(19) United States
(12) Patent Application Publication
(10) Pub. No.: US 2016/0188799 A1
(43) Pub. Date: Jun. 30, 2016

(54) METHOD AND SYSTEM FOR ONLINE DELIVERY OF HEALTHCARE

(71) Applicant: ehumanlife, Inc., Cambridge, MA (US)

(72) Inventor: Carles Vila Borras, Algemesi (ES)

(21) Appl. No.: 14/839,143

(22) Filed: Aug. 28, 2015

Related U.S. Application Data
(60) Provisional application No. 62/043,043, filed on Aug. 28, 2014.

(51) Int. Cl. G06F 19/00; G06T 19/00; H04N 7/15; G09B 5/02

(52) U.S. Cl. CPC G06F 19/321; G06F 19/327; G06F 19/3418; G06F 19/322; G09B 5/02; G06T 19/006; H04N 7/15

(57) ABSTRACT

A computerized system configured to deliver healthcare to patients online. The computerized system may comprise computing devices and external devices that facilitate communication and data transfer between a doctor at one location and patient or another doctor at a different location. The computerized system may enable a doctor to share medical knowledge, such as via webinars, conduct medical consultations and/or teach a patient or medical student. The computerized system may be further configured to recommend a doctor to a patient using a recommendation algorithm. The computerized system may also enable secure transfer of electronic health records in a way that is fast and encrypted to meet HIPAA requirements using HL7.

### RELATED APPLICATIONS

This application claims priority under 35 U.S.C. §119(e) to U.S. Provisional Application Ser. No. 62/043,043, entitled “METHOD AND SYSTEM FOR ONLINE DELIVERY OF HEALTHCARE”, filed on Aug. 28, 2014, which is herein incorporated by reference in its entirety.

### BACKGROUND

Healthcare systems are designed to provide patients access to medical professionals who are trained to diagnose and treat various ailments. For example, patients gain access to doctors via in-person visits at the doctor's office where they are examined and given medical advice. Or, patients may travel via ambulance to a nearby hospital for emergency medical assistance.

Sometimes, patients seek medical information from online resources. Online resources may or may not contain information from medical experts. For example, online forums exist where users can share their experiences with other patients about certain medications or treatments for various illnesses. Other resources online may include webinars, where medical experts deliver a pre-recorded educational lecture on a particular topic. For example, a video may explain the health benefits of staying well-hydrated and the consequences of being dehydrated.

In some instances, medical professionals who manage a physical office will facilitate the administrative portion of their practice using the internet. For example, some doctor's offices have online appointment scheduling and an online payment feature.

Healthcare systems encompass more than just seeing patients and treating ailments. For example doctor's offices and hospitals manage health records for each patient. In addition, healthcare systems manage payments and health insurance to cover services.

### SUMMARY

Accordingly, in one aspect, the invention may relate to a method of operating a healthcare delivery system to recommend a doctor in response to an indication of need for a doctor for a patient. The method may comprise the act of, with at least one processor of an online healthcare delivery system, accessing patient factors based at least in part on information received from the patient over a computer network, wherein the patient factors comprise symptom information. The method may further comprise the act of, for each of a plurality of doctors, accessing doctor factors stored in a data store within the online healthcare delivery system, wherein the doctor factors comprise specialty information. The method may further comprise the act of calculating a respective doctor score based on the doctor factors and the patient factors and sorting at least a portion of the plurality of doctors based on the respective doctor scores.

In another aspect, the invention may relate to a system for enabling a healthcare professional at a first location to teach a user, at a second location, about a healthcare topic, wherein the first location and the second location are coupled to the system via a computer network. The system may comprise a source of an image of at least a portion of a human anatomy. The system may further comprise at least one processor configured with an augmented reality program to provide an augmented reality depiction of an image from the source, wherein the operation of the augmented reality program is based on input received over the computer network from at least one input device at the first location. The at least one processor may be further configured to send the augmented reality depiction for display on a computing device at the second location. Alternatively or additionally, the depiction may be a 3D representation. That information may be displayed via the computing device at the second location, which may be a personal computer or other suitable computing device, such as a mobile device executing an app that interfaces to the system over the network.

In yet another aspect, the invention may relate to a system for enabling a patient, at a second location, to consult with a doctor, at a first location, the first location and the second location being connected by a computer network. The system may comprise at least one computing device configured to provide a plurality of communication pathways between the patient and the doctor over the computer network. The plurality of communication pathways may comprise a first communication pathway for conveying signals representing a video conference and a second communication pathway for conveying health signals from a sensor coupled to the patient during the video conference communication.

In yet another aspect, the invention may relate to a method of providing webinar content within an online healthcare system. The steps may comprise receiving a bid from at least one sponsor to sponsor content generated by a doctor, determining a selected sponsor based on the at least one bid, receiving a logo from the selected sponsor, and associating sponsor information with the content. The method may further comprise receiving content from the doctor, organizing content based on doctor factors and content factors and storing content in a content library on a server. The method may further comprise receiving search criteria based on patient factors, performing a search of the content library based on the search criteria, displaying the content library via embedded video and displaying the sponsor information associated with the content adjacent to the content.

In yet another aspect, the invention may relate to a method of managing access to electronic health records stored on at least one computing device. The method may comprise receiving authorization from a patient to provide access to health care records of the patient to a healthcare provider. The method may further comprise generating security and access information for the health care records, wherein at least one of the security and access information has a time limit associated therewith, and providing the security and access information to the healthcare provider.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an illustrative diagram of online healthcare delivery system;

FIG. 2 is a flowchart of an illustrative process, in accordance with some embodiments, for recommending a doctor to a patient;

FIG. 3a is a conceptual illustration of an exemplary embodiment of an online healthcare delivery system for delivering medical information to a patient from a patient's perspective;

FIG. 3b is a conceptual illustration of an exemplary embodiment of an online healthcare delivery system for delivering medical information to a patient from a doctor's perspective;

FIG. 3c is a conceptual illustration of an exemplary embodiment of an online healthcare delivery system for delivering medical information to a patient from a patient's perspective in a scenario in which multiple doctors collaborate in provide health services to a patient;

FIG. 3d is a conceptual illustration of an exemplary embodiment of an online healthcare delivery system for delivering medical information to a patient from a patient's perspective in a scenario in which a doctor is controlling a 3D representation of an organ to explain a medical procedure to a patient;

FIG. 4 is a conceptual illustration of an exemplary embodiment of an online healthcare delivery system for uploading and viewing patient vital information;

FIG. 5a is a flowchart of an illustrative process for providing a user with access to webinar content, in accordance with some embodiments;

FIG. 5b is an exemplary graphical user interface through which a library of webinar videos may be displayed;

FIG. 5c is an exemplary graphical user interface through which a user-selected webinar video and an associated sponsor logo may be displayed;

FIG. 6A is a flowchart of an illustrative process for allowing access to patient electronic health records, in accordance with some embodiments;

FIG. 6B is a flowchart of an illustrative process for allowing access to patient electronic health records, in accordance with some embodiments;

FIG. 7 is an exemplary graphical user interface through which a payment may be made by the user to pay for the services of the online healthcare delivery system, in accordance with some embodiments;

FIG. 8a is an exemplary graphical user interface through which an appointment with a doctor may be made by the user, in accordance with some embodiments;

FIG. 8b is an exemplary graphical user interface through which a payment may be made by the user for the chosen appointment with the doctor, in accordance with some embodiments;

FIG. 9 is an exemplary graphical user interface through which a patient review of a medical service purchased may be submitted, in accordance with some embodiments;

FIG. 10 is an exemplary graphical user interface through which a doctor can manage appointments scheduled, in accordance with some embodiments;

FIG. 11 is an exemplary graphical user interface through which a doctor can manage billing rates, in accordance with some embodiments;

FIG. 12 is a block diagram of an exemplary computer system that may be used in performing some or all of the computations described herein; and

FIG. 13 is an exemplary graphical user interface through which a patient can manage a user account, in accordance with some embodiments.

### DETAILED DESCRIPTION OF INVENTION

The inventors have recognized and appreciated, through the appropriate configuration of hardware and software resources, a computerized system can alleviate shortcomings of existing approaches to deliver healthcare. For example, conventional methods of delivering healthcare involve non-anonymous, in-person meetings that may require the patient to travel long distances to access healthcare. Additionally, many healthcare providers only provide service to patients with health insurance. The inventors have recognized that these requirements present a burden and possible impediment to access to healthcare for some patients.

An online healthcare delivery system may be configured in a way to deliver high-quality, medical consultations to more patients and in less time regardless of a patient's location. Moreover, the hardware and software resources may be configured to perform functions that would not be possible using traditional approaches, such as enabling consultations to be anonymous. As an example of further features that may be provided, an online healthcare delivery system may include a teaching system that helps a doctor communicate with a patient about their health and show the patient how to take care of themselves. For example, a doctor may show a patient how to clean and bandage a wound in a way that is clear and easy to for the patient to understand without the doctor being physically present with the patient. An online healthcare delivery system may also be configured to allow a doctor to see a patient's vital health statistics remotely and in real-time. A doctor in London may use the real-time data as a basis for diagnosing an illness or monitoring progress of a patient in New York, for example. Furthermore, the online system may eliminate the need for health insurance by allowing the patient to make payments directly to the doctor. Additionally, the online system may be configured to maintain the patient's privacy by allowing anonymous consultations. For example, a patient may be able to see a doctor. Though the doctor may receive from the system medical records for the patients and interact with the patient, the doctor may not be able to know the identity of the patient.

The inventors have also recognized and appreciated techniques, implemented through such a system, for an improved healthcare system with better access for patients in less time. Such techniques include recommending the most suitable doctor for a patient during an emergency call so that the patient can quickly contact the best doctor for their situation. Another technique may involve securely enabling access to a patient's electronic health records. Yet another technique may involve providing access to medical knowledge for patients and other members of the medical community.

The following figures provide examples of possible embodiments of such a system. Such a system may employ sensors and other sources to obtain data about the patient and provide that information to a doctor providing a medical consultation. The embodiments illustrated in the figures are exemplary and not limiting of the invention.

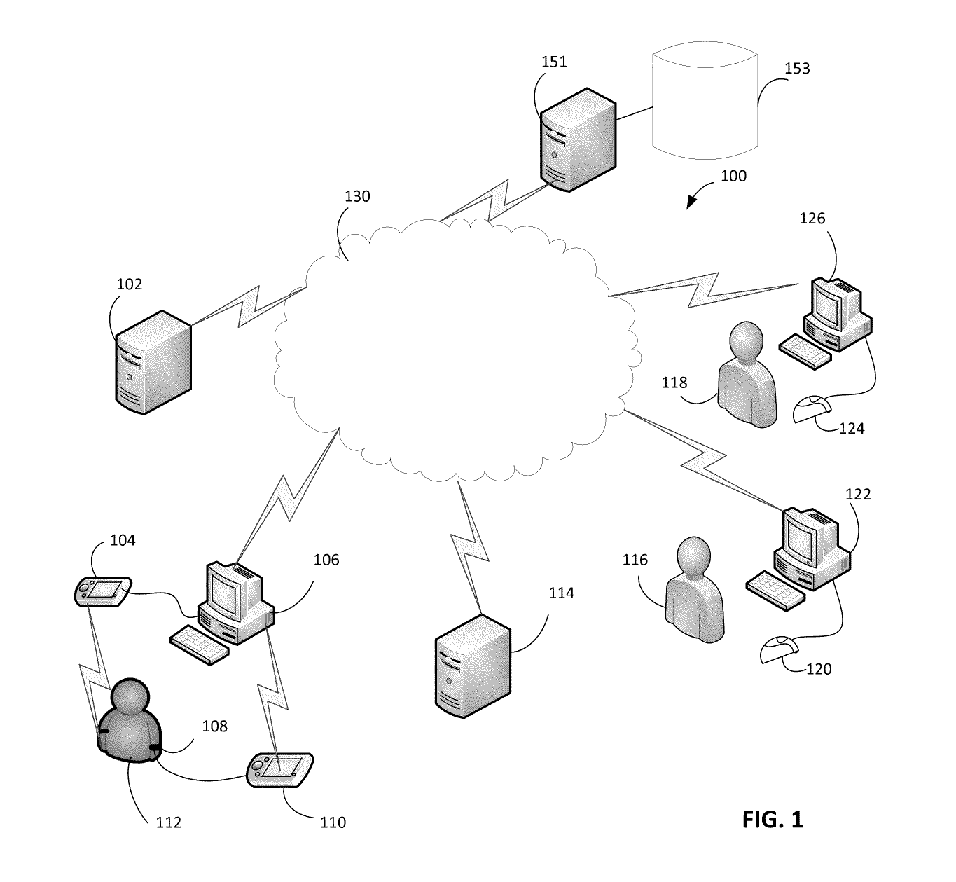

FIG. 1 provides an example of an online healthcare delivery system 100. In this example, users 112, 116 and 118 are illustrated. User 112 may be a patient and users 116 and 118 may be medical experts. Each of the users has a computing device 106, 122 and 126, respectively, connected to a network 130. The computing devices may have any suitable form. For example, a user may access an online healthcare delivery system through a desktop computer, a tablet, a smart phone or other portable computing device.

Regardless of the type of computing device, each of the computing devices may have installed on it an application or otherwise be configured for accessing the online healthcare delivery system. However, the specific mechanism by which a user accesses the online healthcare delivery system is not critical to the invention.

Network 130 may be any suitable network. Moreover, it should be appreciated that network 130 may have subnets, such as a LAN or WAN linked through other networks. In the examples provided herein, users of the online healthcare delivery system are connected through a wide area public network, such as the Internet.

The online healthcare delivery system may contain servers or other device also connected to network 130 that manage healthcare information among users of the online healthcare delivery system 100. In this example, servers 102 and 114 are shown connected to network 130 for this purpose. Server 102, or other suitable components in the online healthcare delivery system, may store a patient's electronic health records. Server 114 may store and manage user information such as account information, billing information, and/or scheduling information. Either or both of these, or other suitable server (not shown), may store content, such as webinar material, that may be provided to patient or healthcare provider users.

The online healthcare delivery system may contain or interface with external devices 104, 108, 110, and 120. In this example, external devices 108, 104 and 110 may sense and/or measure vital statistics patient 112. For example, device 108 may be a blood pressure sensor. Alternatively, device 108 may be a pulse sensor. By way of example and not limitation, devices 110 and 104 may be meters configured to measure and/or process the vital signals. Additionally, devices 110 and 104 may be communication devices such as a phone or tablet configured to relay the vital signals to the online healthcare delivery system.

Information collected with external devices such as 104, 108, 110, and 120, may be selectively made available to a healthcare provider user. In some embodiments or in some scenarios, the information may be stored as part of a patient's health record, such as on server 114 as part of a secure account for the patient. A healthcare provider user may receive from the system access to that information when a patient user selects that healthcare provider. Alternatively or additionally, a patient user may connect to one or more sensors, which may be configured to stream data about the patient as part of an electronic communication session with a healthcare provider. In that scenario, a patient user agreeing to engage in an electronic communication session with a healthcare provider user provides a form of consent to the system to make the sensor data available to healthcare provider user.

The system enables interaction between a patient user and a healthcare provider user, such as a doctor. This interaction may be so that the doctor may diagnose a current medical condition of the patient and/or prescribe treatment for it. The interaction may also allow the doctor to follow the progress of the patient, for example, checking periodically for signs of a relapse or side effects of treatment. In some embodiments, the system may support one or mechanisms, including 3D or augmented reality presentations, for the doctor to educate the patient about a particular medical treatment or treatment.

However, interactions are not limited to those done for diagnosis or treatment. The system may provide a mechanism for the doctor to communicate to the patient information unrelated to a specific diagnosis or treatment. The system may enable a patient to view formal or informal webinars and other educational material. The material appropriate for a patient to access may be selected by a doctor. Alternatively or additionally, the system may include search functions that access one or more data stores to identify relevant information.

Alternatively or additionally, the system may enable communication between any number of parties with any roles. For example, the system may enable communication between doctors. In embodiments when all doctors have access through the system to information about the same patient, this feature may support consultations among doctors. The system may also support interactions between doctors and students. In this way, the system may be used for training.

Further, the system may support access to information. Such information may be accessed by any user. In some embodiments, a doctor may access the system to gain information about a patient with a medical condition about which the doctor lacks information. FIG. 1, for example, shows a server 151 which may form a portion of the system in some embodiments. Server 151 may be programmed with a search engine that receives some form of query. That search engine may access a data store 153 to find information with a high relevance with respect to the query. Here data store 153 is illustrated as a single database. However, it should be appreciated that a data store may be in any suitable format, including distributed across a network such as the Internet.

A search engine may also employ any suitable algorithm. In some embodiments, the search engine may be a keyword search engine, using a page rank or similar algorithm to find pages of information that are relevant to a query. In some embodiments, the search algorithm may filter or modify the query or search results based on context information. Context information may include geographic context of the doctor or patient. The system, for example, may, in ranking search results, attach lower weight to information about tropical diseases for patients in Alaska. Alternatively, the system, because if has access to patient information may use patient specific information as context for a search. This context information may be associated with a search, even if performed by a doctor, if the search is associated with a patient. Using such context may enable the system to identify specifically relevant search results. For example, a doctor interacting with a patient suspected of a heart condition may conduct a search for recommended treatments. If the patient also has high blood sugar, the search engine may access this context information to preferentially return to the doctor in response to the search information about treating patients with the heart condition and high blood sugar.

Such a search may be entered in any suitable way. In some embodiments, the search engine, rather than receiving keywords in a search query, may receive as input questions. The search engine, in this case, may include a natural language processing engine or other suitable component to construct a query based on a question or series of questions posed by a user. Here, the context information may include information in the patient's health record as well as other information, such as prior interactions with the system. Such searches may be conducted either within or outside sessions in which patients and doctors communicate via the system.

In a scenario in which the system is used to enable interaction between a patient user and a healthcare provider user, the patient user may initiate that interaction with a selected healthcare provider user. Any suitable method may be used for the patient to identify and select a healthcare provider user. However, in some embodiments, the system may make a recommendation of a specific healthcare provider user or may suggest multiple healthcare provider users from which a patient user may make a selection.

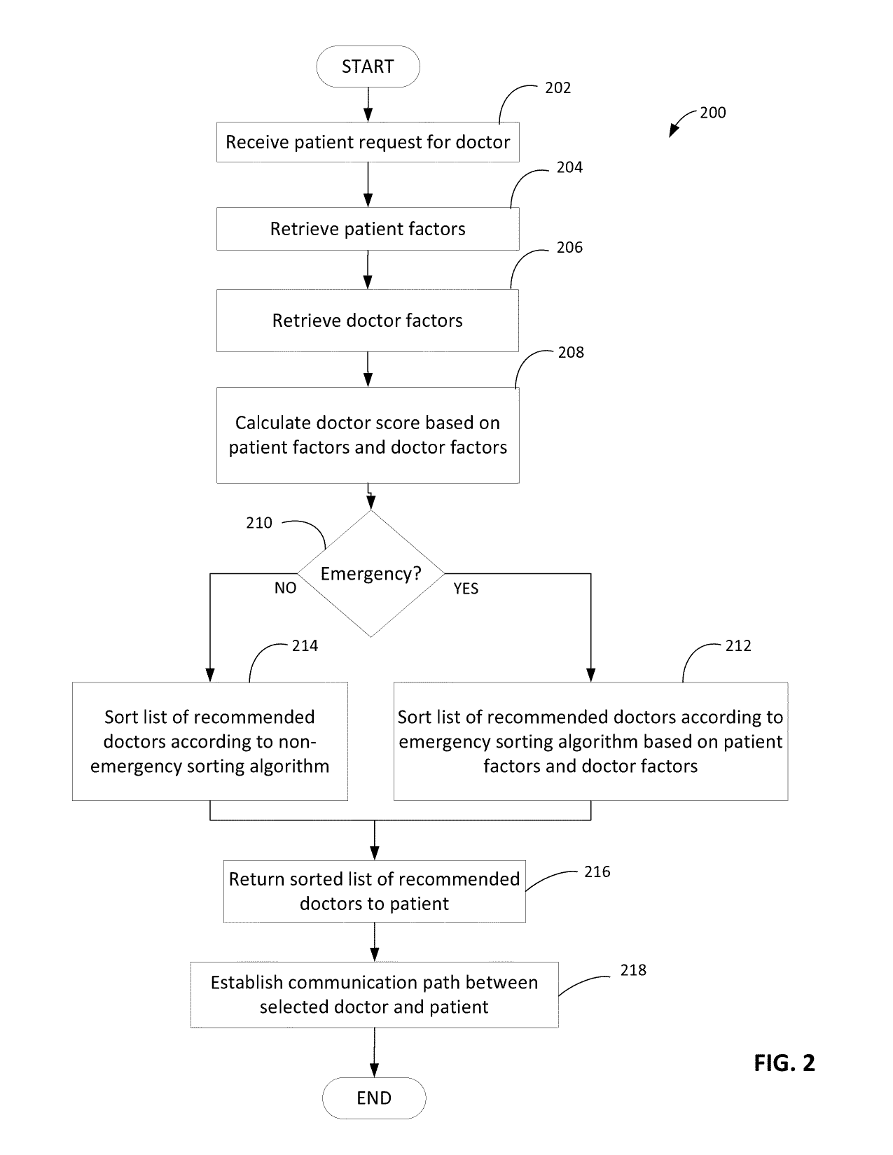

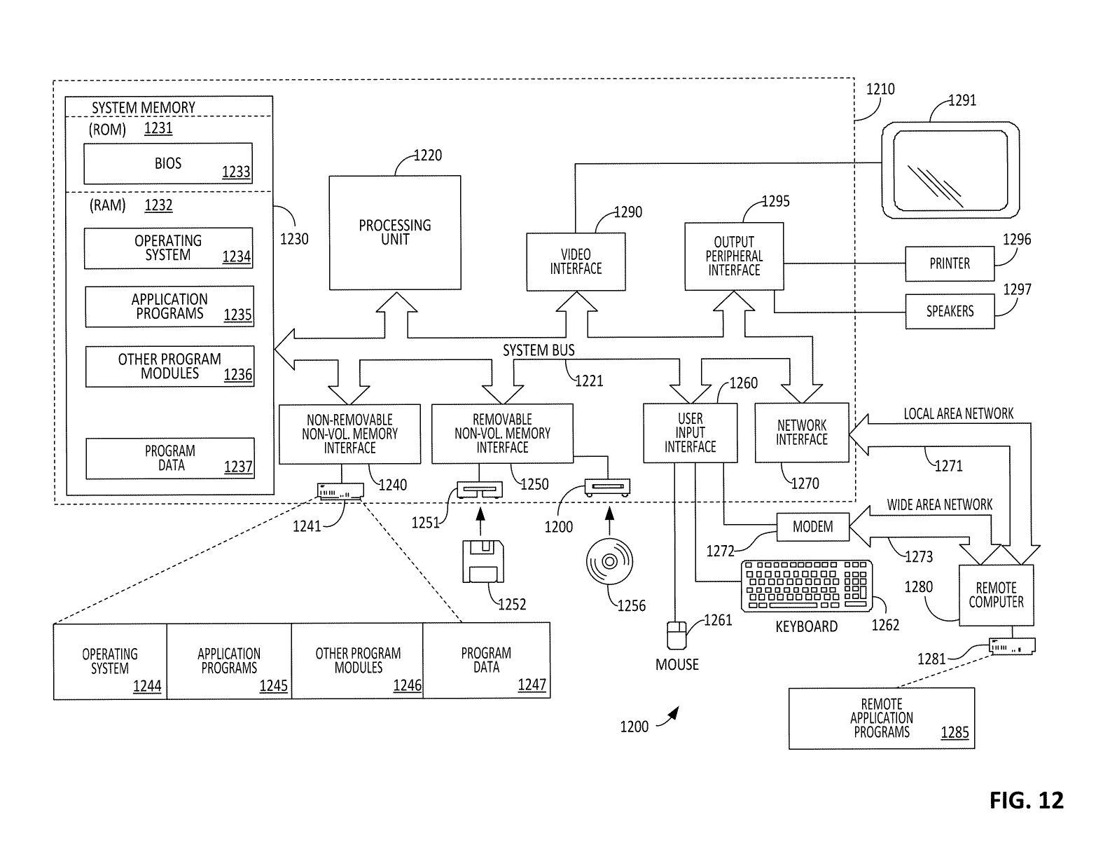

FIG. 2 shows a flowchart of illustrative process 200 for recommending a doctor to a patient. Process 200 may be executed by any computing device and, for example, may be performed by computing system environment 1200. In particular, in some embodiments, some or all of the acts of process 200 may be performed by processor 1220 described with reference to FIG. 12.

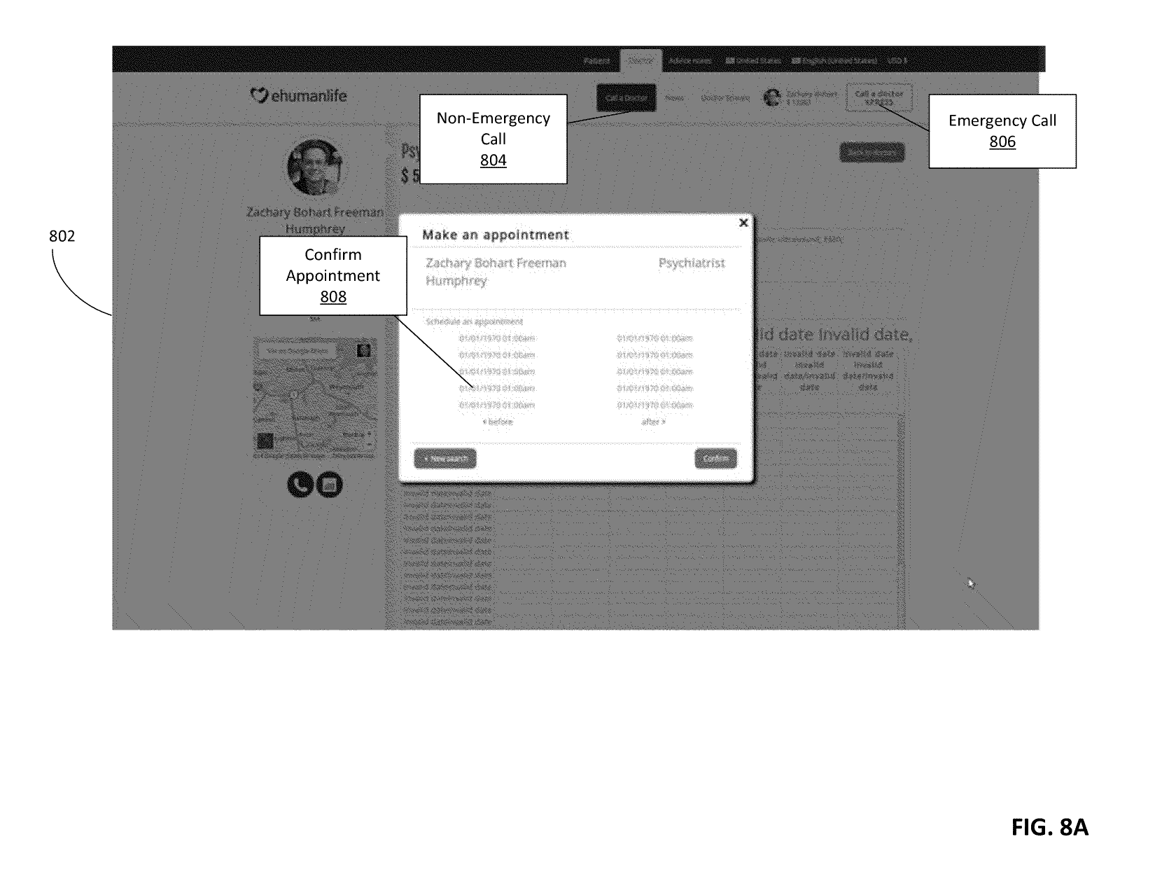

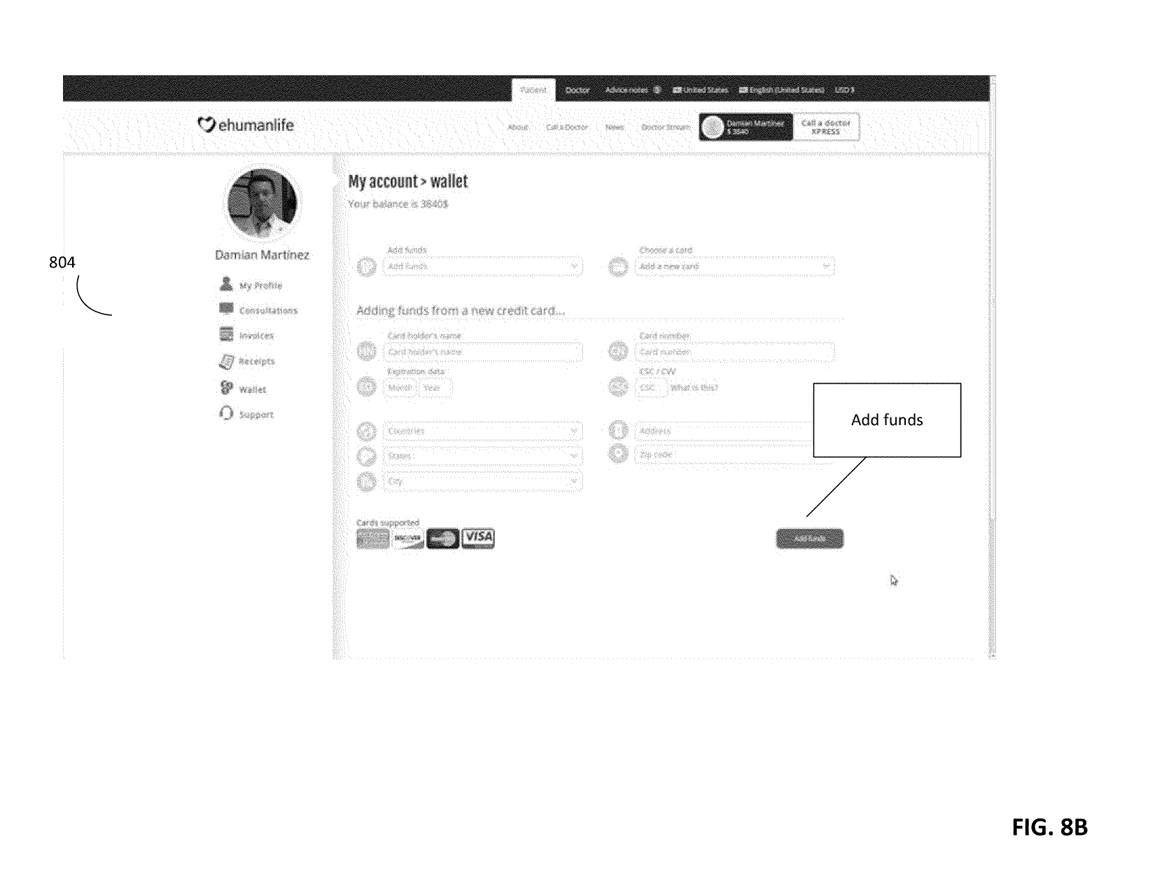

Process 200 begins in act 202, where the system receives a patient request for a doctor in any suitable way. For example, a patient may click a non-emergency call button 804 or an emergency call button 806 on an exemplary graphical user interface 802 called “call a doctor” or “emergency call”, respectively, in the embodiment illustrated in FIG. 8a.

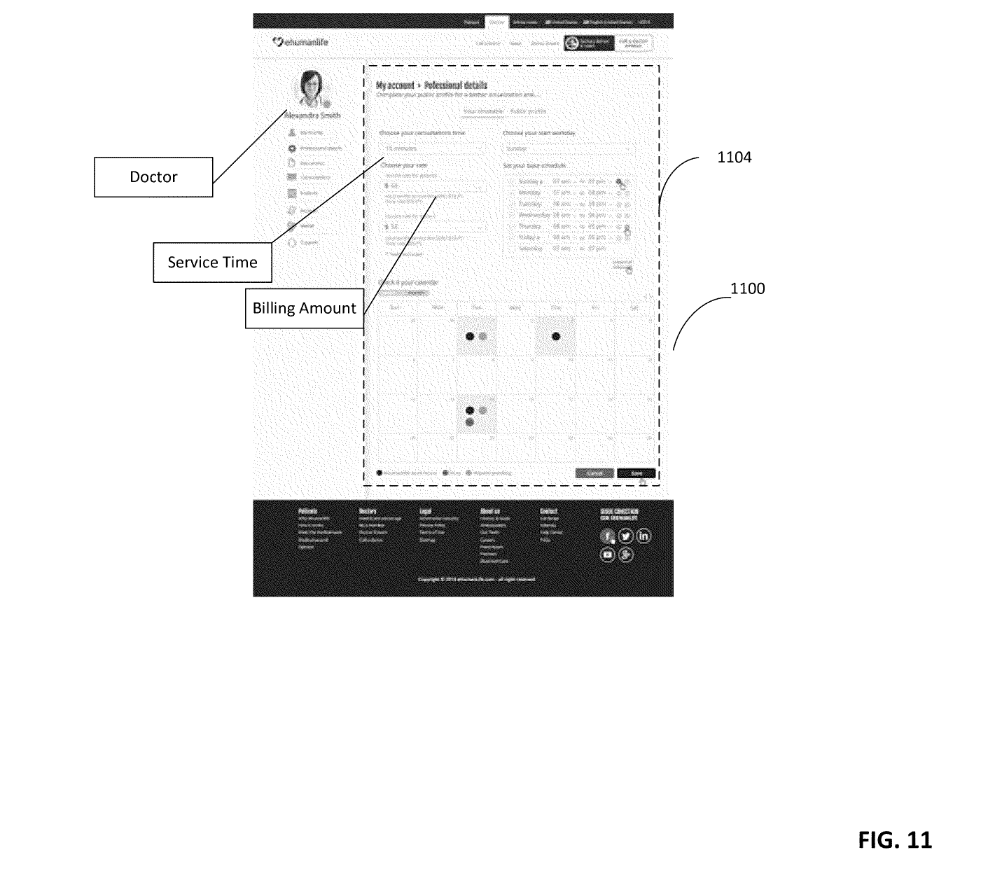

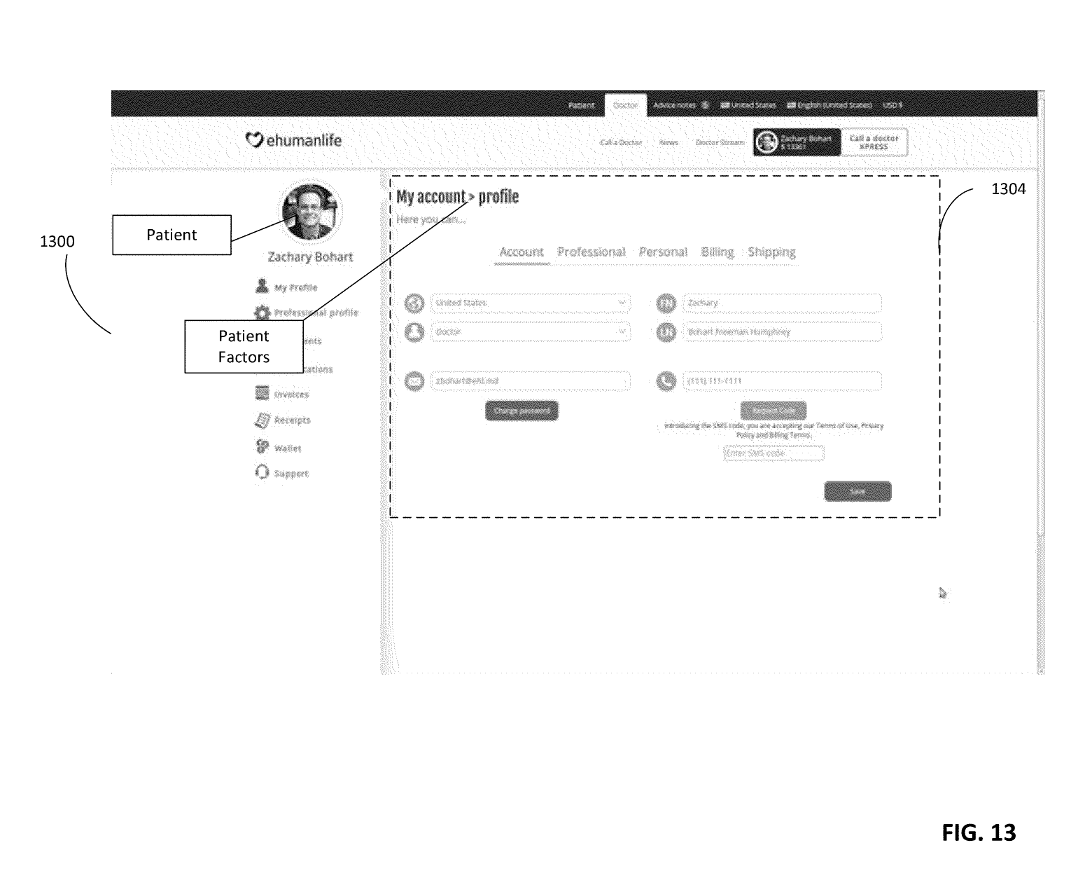

Next, process 200 proceeds to acts 202 and 204, where the system retrieves patient factors and doctor factors in any suitable way. For example, a patient may enter some patient factors into a user account using patient factor input section 1304 as shown in FIG. 13. Similarly, a doctor may enter some doctor factors into a user account using a doctor factor input section 1104 as shown in FIG. 11. These factors may be stored in and retrieved from server 114 using techniques known in the art. Patient factors may include, but are not limited to, identification information for billing purposes, age, sex, location, symptoms, health history, past doctors used, and/or current level of funds. Doctor factors may include, but are not limited to, identification information, age, sex, race, location, past patients seen, specialty, reviews from patients and/or billing rate. These factors may be entered by the patient and/or doctor upon initial use of the system. Alternatively or additionally, these factors may be augmented based on data collected as the system operates. For example, sensor data, diagnoses, symptoms or other information about the patient may be collected by the system as the patient interacts with the system over time. For a doctor, the system may collect information about the doctor's experience in treating different types of patients or information feedback from other patients who have consulted with the doctor. This information may be stored in a data store, such as a database managed by server 114, and used as part of an automated process for selecting a doctor appropriate for a patient.

Other doctor factors may be measured and collected by the system and stored in server 114 in any suitable way. These factors may include, but are not limited to, doctor availability and/or activity online, doctor response time, and/or length of call. Some factors that measure time may be automatically tracked using timestamps. For example, to measure doctor response time, at the time a patient makes a call to a doctor a timestamp may be triggered to fire and the system begins tracking the time it takes for a doctor to respond to the call or arrive to the location where the appointment it held.

Next process 200 proceeds to act 208, where a doctor score may be calculated in any suitable way. For example, a doctor score may be calculated based on doctor factors and/or patient factors. Any combination or weighting of doctor factors and/or patient factors may be used in the determination of a doctor score. For example, a point-system may be implemented where points are given to weight certain factors. The points for each factor may be added up and averaged to determine a doctor score. The system may calculate a score for each of multiple doctors. The doctors for which scores may be calculated may be a subset of the doctors registered with the system. The subset may be selected in any suitable way, such as by geography, availability or doctor specialty.

Next, process 200 proceeds to act 210, where processing branches based on an indication of urgency associated with the call. For example, the patient may need emergency assistance and may indicate this need by selecting a button. For example, as discussed above, the system may receive a button click on either the non-emergency call button 804 or the emergency call button 806 on the exemplary graphical user interface 802, with reference to FIG. 8a.

If an emergency call button was clicked, then process 200 proceeds to act 212, where a list of recommended doctors may be sorted in any suitable way. For example, a list of recommended doctors may be sorted according to emergency sorting algorithm based on patient factors and doctor factors. The emergency sorting algorithm may be implemented in any suitable way. For example, a point-system may be implemented where points are given to weight certain factors. The points for each factor may be added up and averaged to determine a doctor score. The system may average different factors or award different amounts of points based on the scenario in which the recommendation is requested, such that different scores may be generated for emergency and on non-emergency call scenarios.

If a non-emergency call button was clicked, then process 200 proceeds to act 214, where a list of recommended doctors may be sorted in any suitable way. The non-emergency sorting algorithm may be implemented in any suitable way. For example, a point-system may be implemented where points are given to weight certain factors. The points for each factor may be added up and averaged to determine a doctor score. In some embodiments, a predetermined number of doctors, such as six, may be selected. Those selected may be the highest scoring doctors with immediate availability or that meet other suitable criteria.

Next, process 200 proceeds to act 216, where the sorted list of recommended doctors may be returned to the patient in any suitable way. For example, the sorted list may appear on the graphical user interface similar to interface 802 with reference to FIG. 8a. In presenting the list, the system may automatically select only the top highest scoring doctors or apply other filtering criteria, such as presenting only doctors that scored above a threshold amount. The patient may then select among the list of recommended doctors. Such selection may be made using graphical user interface techniques or in any other suitable way.

Next, process 200 proceeds to act 218, where communication between the patient and the doctor may be established in any suitable way. For example, in response to patient input selecting a doctor, the system may call the selected doctor. Such a call may be a voice call. Though, in some embodiments, the call may be an audiovisual call using VoIP communication or other suitable communication technology that enables the “call” to be communicated over a network, such as network 130 (FIG. 1). In some embodiments, the call may be placed immediately following user input, in other embodiments, the call may be at a later time. For example, processing at block 218 may entail scheduling on-call at a time when the selected doctor and patient are both available, which the system may identify based on calendar or other profile information in put by each of the selected doctor and patient.

Though not illustrated in FIG. 2, the manner in which a call is established may depend on the manner in which the call was initiated or any other suitable factors. For example, in an emergency call scenario, the system may place the call immediately, using or trying any one or more available modes of communication. For a non-emergency call, the call may be scheduled for a later time.

In some scenarios, a patient's need for medical services may be met without an interactive call between the patient and the doctor. The need, for example, may be met, for example by providing previously prepared and stored educational material to the patient. Such educational material may be requested affirmatively by the patient user. Alternatively or additionally, the system, upon receiving a request for a “call” may ascertain that the patient's current request can be met by prestored information rather than an interactive consultation with a doctor. For example as part of receiving patient factors for selecting a doctor, the system may collect information about current patient symptoms or scenario prompting the patient to seek a consultation with a doctor. The system may use such information to determine that pre-stored information may be relevant and offer the patient the option to access that information at a lower or reduced cost instead of or in addition to arranging a consultation with a doctor.

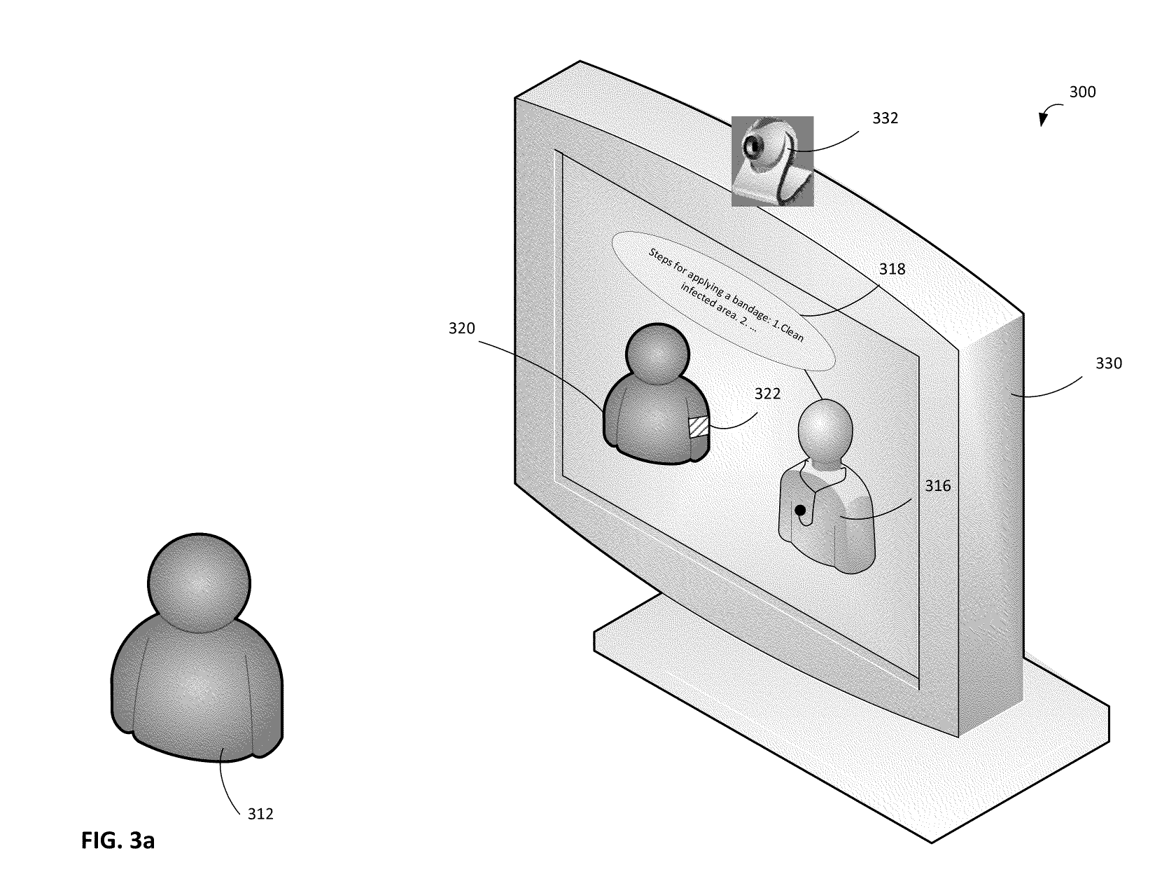

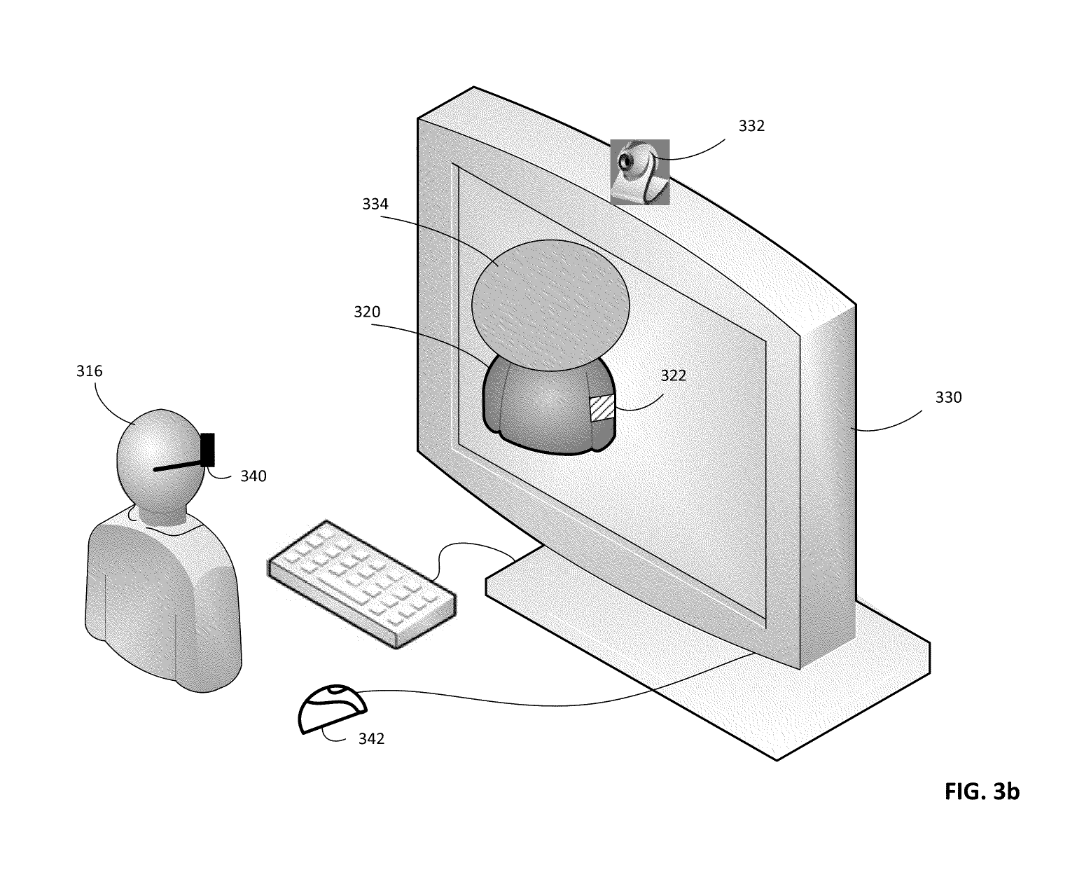

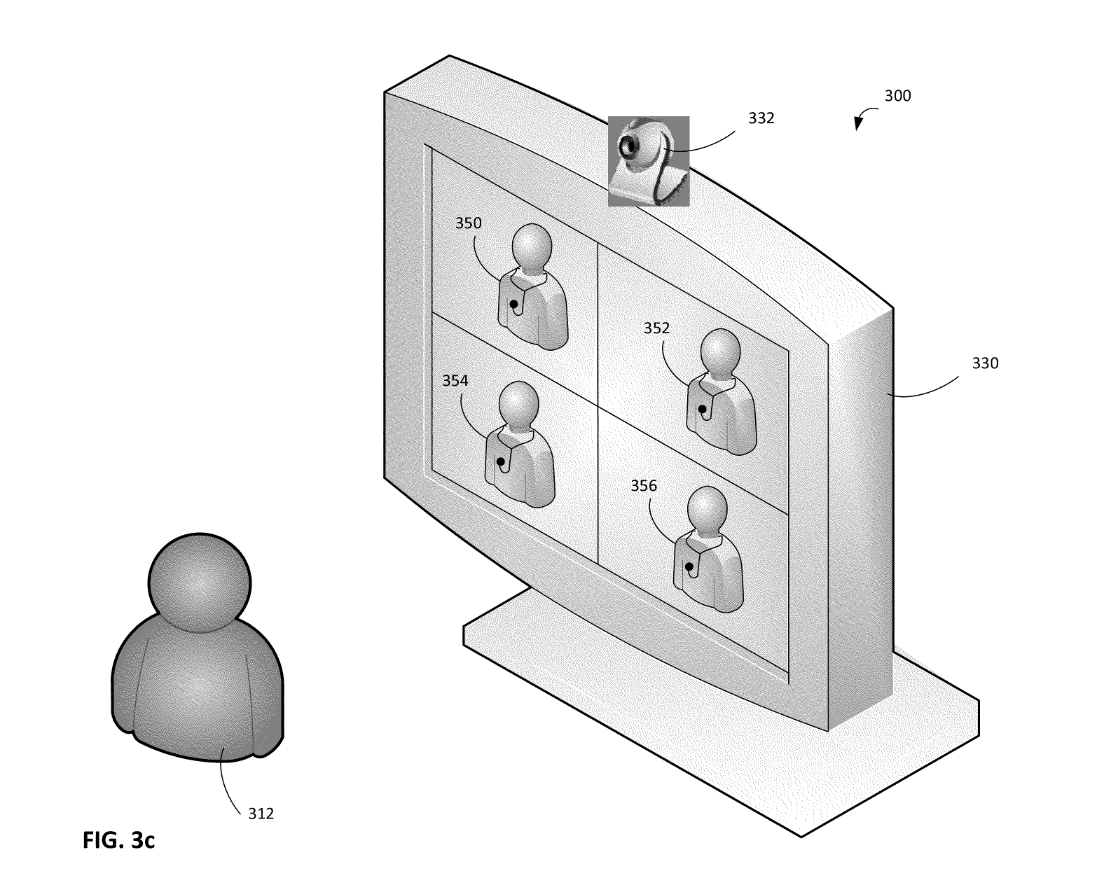

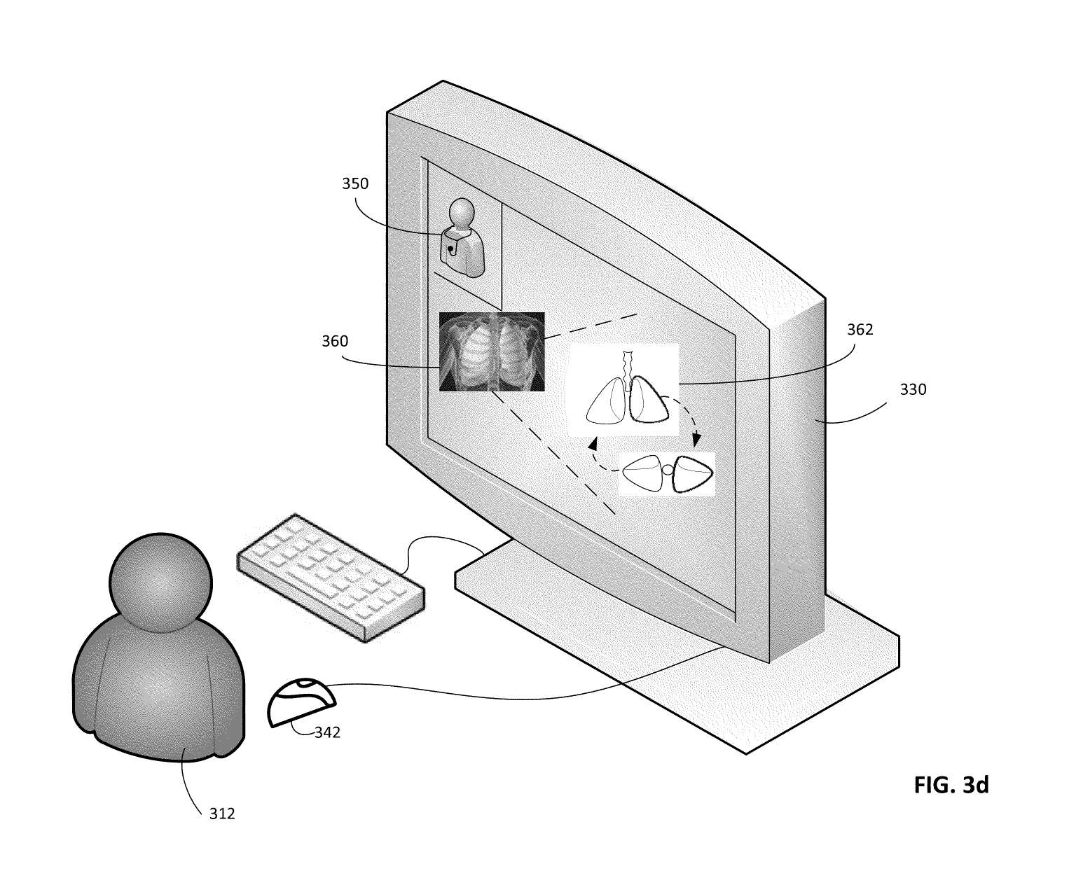

FIG. 3a-3d provides an example of a teaching system 300 within the online healthcare delivery system 100. In this example, user 312 and 316 are illustrated. In the embodiment illustrated, user 312 may be a patient or a medical student, and user 316 may be a medical professional. In this example, user 312 is interacting with the system in a live mode. User 316 may also be interacting with the system in a live mode, but from a different location that user 312. User 312 and 316 may interact using real-time audio-video communication over network 130 and depiction of user 316 may represent a video image of user 316 as seen by user 312 at the different location. Alternatively or additionally, user 316 may have previously prepared teaching content that is stored within the system and presented to user 312. In that scenario, the depiction of user 316 in FIG. 3b may represent a recorded image of user 316.

A teaching system 300 may be implemented in any suitable way. For example, teaching system 300 may include a computing and viewing device 330 with a webcam 332. The viewing device 330 may be configured to provide a live video and audio conference where the patient can see and communicate with a doctor 316. The video conference may allow a doctor in one location to teach a patient in another location how to care for him or herself in any suitable way or otherwise provide medical information to user 312. In the embodiment illustrated, doctor 316 is explaining how to clean and bandage a wound in bubble 318. The video conference may be equipped with augmented reality software that shows an image 320 of the patient, taken with webcam 332, and the steps being performed on the patient. In augmented reality, a computer-generated image of a bandage 322 may be superimposed onto the image of the patient 320. The image of the patient 320 may include a portion of the anatomy of patient 320. Augmented reality may similarly be used to teach user 312 about other steps the user may take or conditions the user may be expected to observe.

In other embodiments, a medical student 316 may use the system to learn how to perform surgery on a specific organ. For example, a 3D image of an organ may be shown as a surgical subject. The system may show what happens if a cut in the artificial organ is done in different ways by changing the image presented to the student user. These images may be computer-generated, prerecorded or obtained in any other suitable way.

Teaching system 300 may include any suitable external control devices to control the augmented reality images. In FIG. 3b, the teaching system includes a controllable headset 340 and mouse 342 at the doctor's location. Alternatively, the teaching system may include a virtual reality headset such as Oculus Rift immersion glasses. The doctor 316 may teach the patient in any suitable way using these external control devices. For example, the doctor may use the headset 340 or the mouse 342 to rotate the 3D and/or augmented reality images to give the patient and/or medical student different views of the procedure. When the patient or medical student views the image in different positions in a more life-like way, they may better learn and understand the concept being taught.

FIG. 3c illustrates a further operating state that may be supported in some embodiments. In this example, user 312 may be a patient seeking medical advice or may be a medical student being trained or may be a doctor seeking a consultation with other doctors around the world. However, rather than interacting with a single doctor, the system may support communication between user 312 and multiple doctors. Here, doctors 350, 352, 354 and 356 are illustrated. Those multiple doctors may appear in separate windows of the user's computing device and each may be able, through the system, to establish a communication path with user 312. Moreover, the system may establish communication among doctors 350, 352, 354 and 356, such that each may use the system to communicate with the others, with or without user 312 receiving those communications.

Regardless of the number of users that are connected through the system, communication may be established using any suitable channel. In some embodiments, that channel may be an audio-video channel in which data, representing audio and video of each participant, is streamed across a network. Alternatively or additionally, data communicated over the network may be in the form of text, supporting a chat channel.

Regardless of the specific channel of communication used, in some embodiments, the channel may be secured. In some embodiments, a secure channel may be established by encrypting the data passing over the network using a key associated with the user such that only the user, and others whom the user has authorized by sharing the key, have access to that information. Any suitable key sharing technology may be used for this purpose, including key sharing algorithms based on a certificate issued by a certifying authority, which may be a server that is part of the online healthcare delivery system. In some embodiments, the use of keys or other security information issued by a certifying authority may enable the users computing device that that the doctor or other party in communication with the user is “authentic.”

Further, in some embodiments, other security mechanisms may be used in of or in addition to keys and/or certificates. For example, the system may maintain, as security information, photographs or other biometric information about authorized doctors. The system may, at one or more times during a session, take a photograph, voice sample or otherwise capture biometric information about the user providing medical services and compare that captured information to stored biometric information about authorized health care providers to ensure that user providing the health services is an authorized health care provider or a specific, authorized health care provider selected by a user. These checks, for example, may be performed every 5 to 10 seconds during a session.

FIG. 3d illustrates an embodiment in which the communication channels provided by the system may be used by a doctor to explain a medical treatment or planned intervention to a patient. In this example, the system supports a user interface through which the doctor may present control the presentation of information in graphical form to the patient. In this figure, viewing device 330 is visible to user 312 who may be a patient. In the embodiment illustrated, the system is presenting a window 350 through which the patient may see the doctor, such as in other modes of interaction. Here, the rest of the user display is under the control of the doctor. By making input commands into the doctor's computing device, the doctor may select and manipulate a graphic the system will display on the user's device 330. In this example, the doctor has entered input commands that select an image of a human organ. As a result, the system displays image 362, which is an image of human lungs. The doctor may further enter commands, which cause the system to display on viewing device 330 images representing manipulations to such an organ. The system may support commands representing any suitable manipulations, including manipulations that change the perspective of the organ as presented to the user on viewing device 330 or that represent changes to that organ during a planned medical intervention. In this example, the system, in response to doctor input, shows an image 362 of the lungs. The doctor has entered commands to rotate that image so that a different portion of the lungs is visible. Examples of other suitable commands include commands to modify the graphic, representing an organ, to illustrate the effect of surgery, treatment with drugs or other intervention. Effects of surgery can illustrate an incision or sutures, for example. Alternatively or additionally, the commands may modify the graphic, such as by changing the size or shape of an organ, to illustrate the progression of a disease or the possible progression of the disease without treatment. Other commands may zoom in or out on a graphic presented, show a cross section through the organ, or otherwise change the portion or perspective of the organ appearing on the display.

Though the selection and manipulation of graphics may, in some embodiments, be driven exclusively by the doctor, in other embodiments, the selection and manipulation of graphics may be driven by the patient or both the doctor and patient. In embodiments in which the patient manipulates the graphic, the manipulated graphic may appear on the doctor's viewing device.

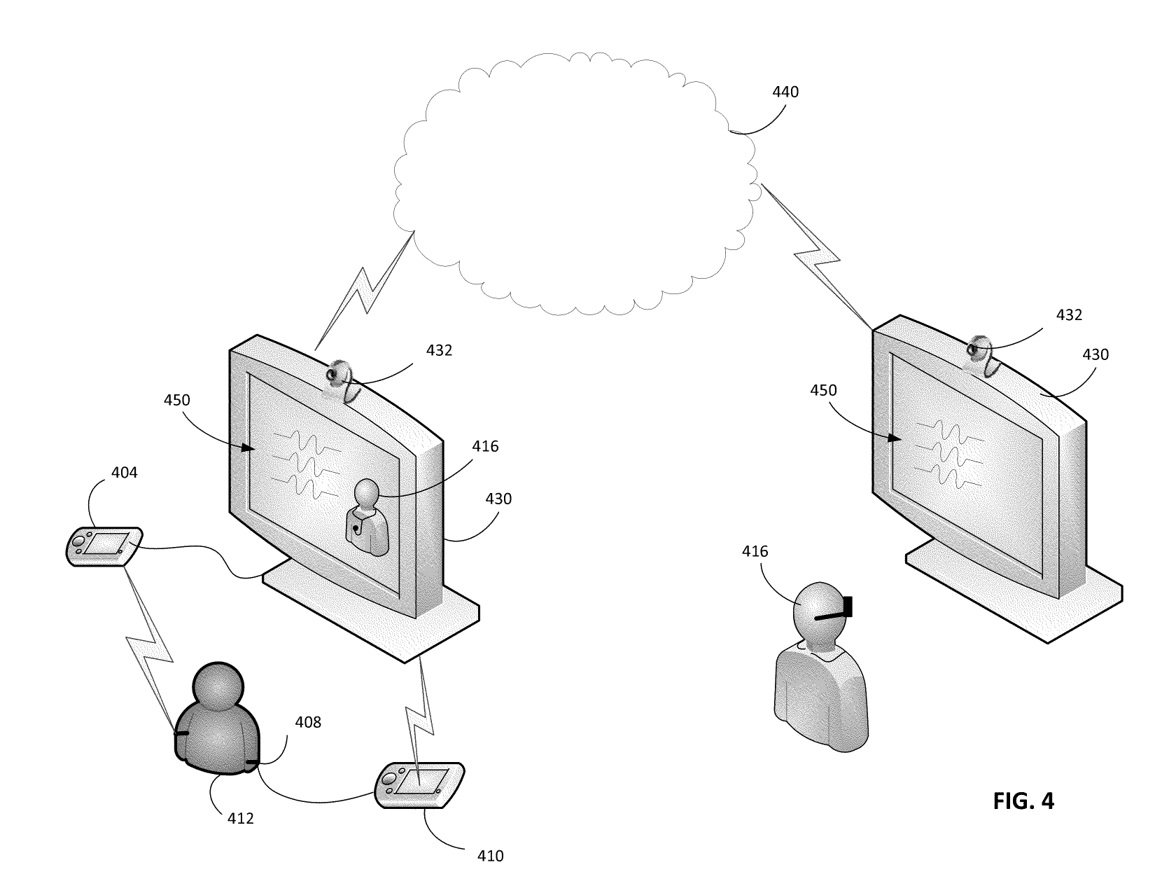

FIG. 4 illustrates an embodiment of real-time communication within the online healthcare delivery system 100. In this example, user 412 and 416 are illustrated. In the embodiment illustrated, user 412 is a patient and user 416 is a doctor.

The real-time communication in the online healthcare delivery system 100 may be implemented in any suitable way improve the quality and speed of the delivered healthcare. For example, patient vital information may be uploaded and viewed in real-time. In the embodiment illustrated, external devices 408 are attached to the patient and configured to sense vital signals 450. However, it should be appreciated that any information about the patient or the patient's environment may be measured, and different external devices may be connected to measure different parameters. External devices 408 may include, but are not limited to, a pulse meter, a thermometer, an electrocardiograph device, a scale, a blood glucose meter or a blood pressure sensor. These signals may be communicated to the doctor through the network 440 in any suitable way. For example, signal communication devices 410 and 404 may be connected to sensors that output signals representing the health of the patient. The signal communication devices process the vital signals 450 and communicate the signals through the network to the doctor's viewing device 430.

Signal communication devices may be in any suitable form and may serve other functions in addition to collecting and communicating signals. Such devices may be or include meters or computing devices configured to process and communicate data, for example, a smart phone or tablet computer. Communication pathways between signal communication devices and the external devices and/or the viewing devices may be implemented in any suitable way. For example, signal communication device 404 and/or signal communication device 410 may have a wired or wireless connection to external device 408 and/or viewing device 430. Sending vital signals remotely eliminates the need for the patient to travel, which saves time and money for the patient. Also, when the doctor can see the patient's vital signals in real-time, the doctor can better understand the patient's health status and can therefore make a better diagnosis and treatment plan.

In the example illustrated in FIG. 4, the signals collected may be presented on a computer screen or other viewing device used by user 416. The signals may be presented with or without processing to extract information. However, the signals collected may be presented to the user in any suitable format.

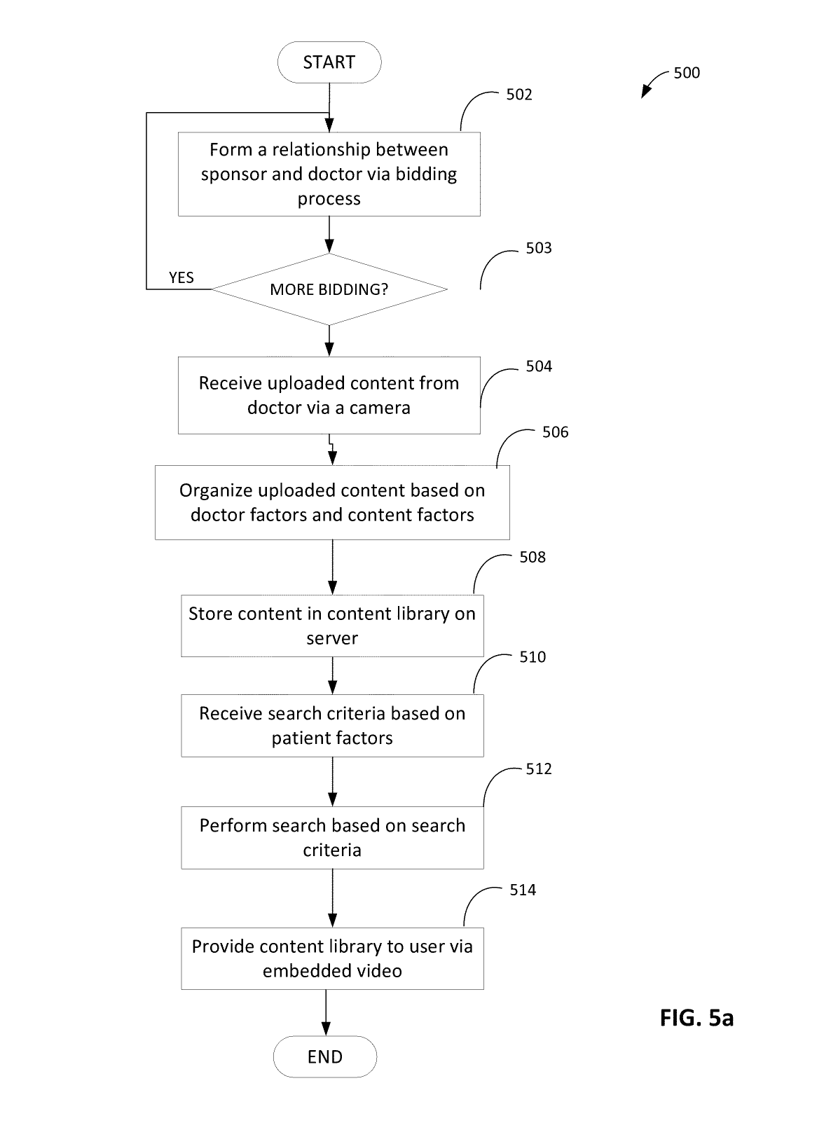

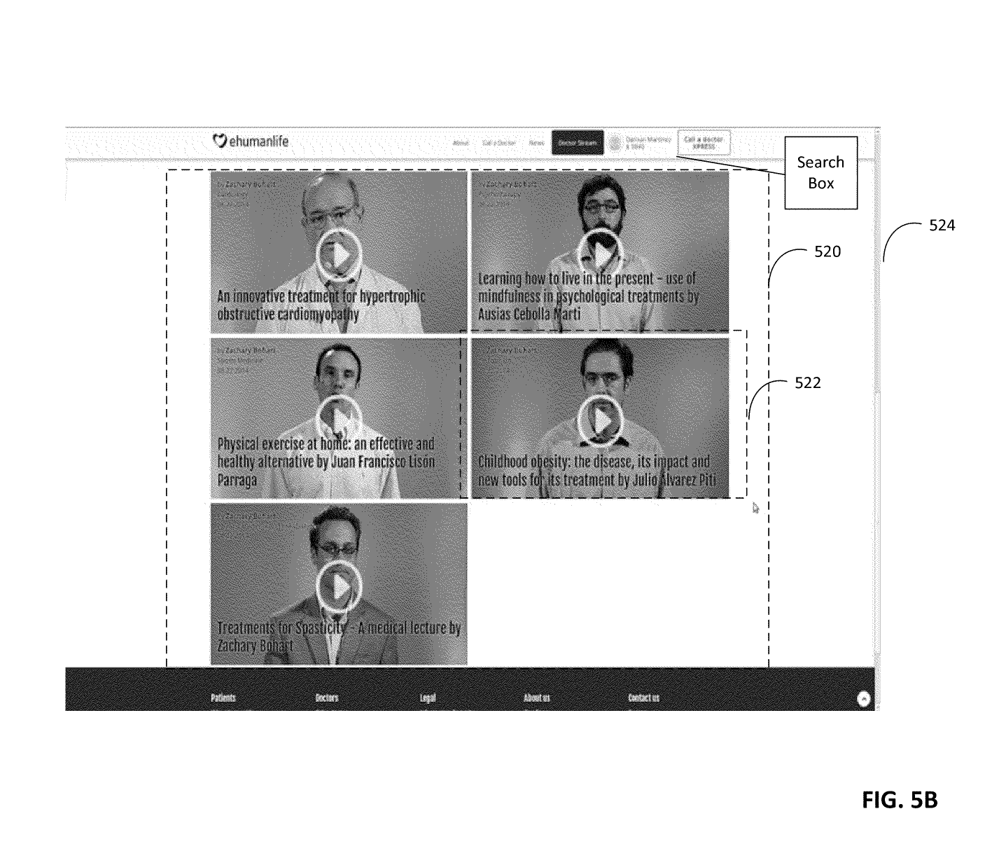

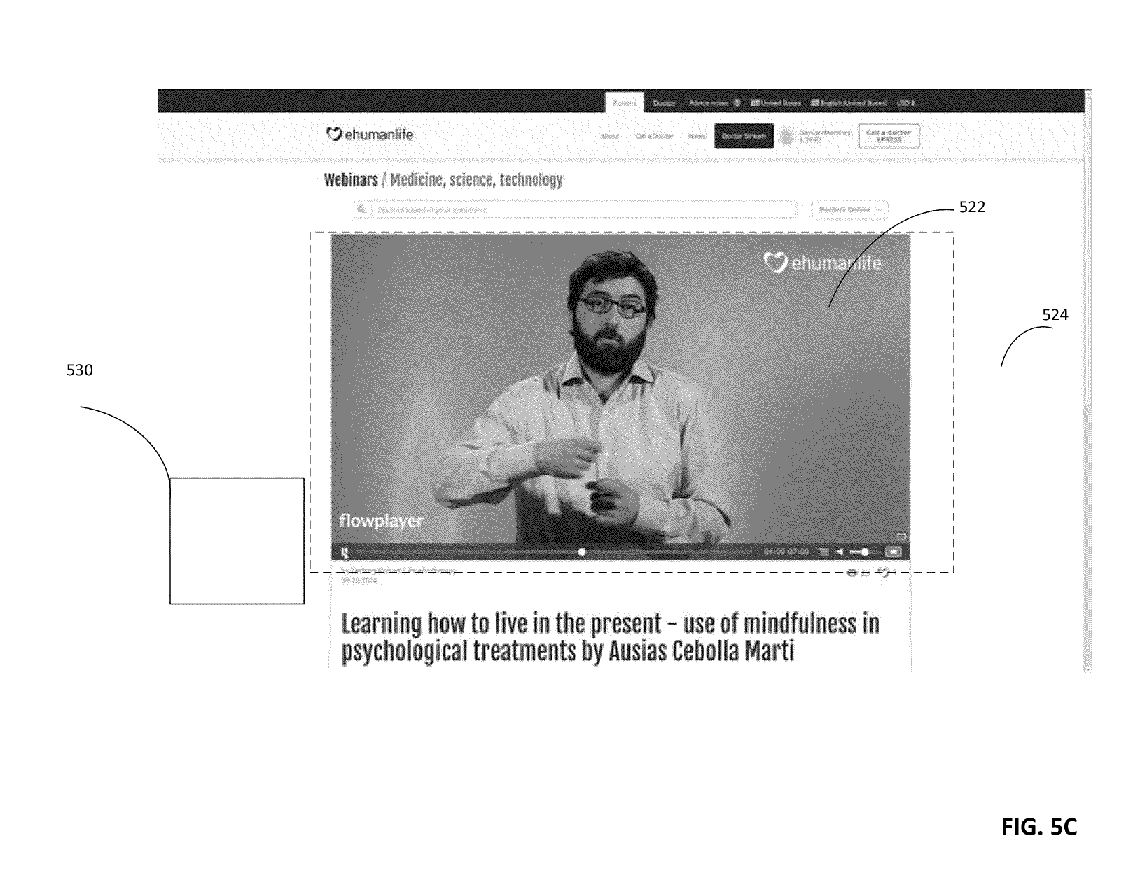

In some embodiments, information may be pre-recorded for later presentation to users. The system may be configured to promote healthcare providers supplying information that may be stored and later presented to users. FIG. 5a shows a flowchart of illustrative process 500 for providing medical knowledge to a user of the online healthcare delivery system 100. Process 500 may be executed by any computing device and, for example, may be performed by computing system environment 1200. In particular, in some embodiments, some or all of the acts of process 500 may be performed by processor 1220 described with reference to FIG. 12.

Medical knowledge may be shared in any suitable way. In the embodiment described in FIGS. 5a-5c, medical knowledge is shared via online video webinars. Alternatively, medical knowledge may be shared in any way known in the art, such as live video stream or audio podcast or text and image-based blogs.

Process 500 begins in act 502, where the system may incentivize a doctor to participate in sharing medical knowledge in any suitable way. For example, the system may offer sponsors space on a graphical user interface 524 next to the sponsored webinar 522 as shown in FIG. 5c in which to place a logo. The sponsor may supply to the system a logo, or other advertisement, which the system may display in the space when content, such as a webinar, provided by the doctor is presented to a user. The system may further implement a bidding process where sponsors may submit a bid to display sponsor information, such as a logo, next to content provided by the doctor. The system may choose the sponsor and logo based on a highest bid for the space. In other embodiments, the doctor may choose the bid and sponsor according to the doctor's preferences, such as working relationships with the sponsor.

In some embodiments, the bidding process may be facilitated electronically. For example, once a potential sponsor places a bid, that bidding party may be notified if another potential sponsor makes a higher bid. The notification may be made in any suitable way, such as via an electronic message or a post to a website accessed by that bidding sponsor. In this way, sponsors may be encouraged to bid.

FIG. 5a illustrates that the bidding process my continue until an ending condition is reached. In process 500, the end of the bidding process may be determined at decision block 503. If, as determined at decision block 503, the bidding is not completed, processing may loop back to act 502 for additional bidding. This determination may be made in any suitable way. For example, the bidding process may be set at the outset to last for a predetermined time, and the process may be determined to end when that time is reached. Alternatively or additionally, any other suitable criteria may be used to determine the end of the bidding process, such as when a target bid is reached, or when a set amount of time has passed since a bid was received.

Next, process 500 proceeds to act 504, where the system may receive uploaded content from the doctor in any suitable way. For example, the doctor may upload content using a webcam 432. Alternatively, the doctor may record the content in a professional recording studio, and the recording studio may upload professionally prepared content.

Next, process 500 proceeds to act 506, where the system may organize uploaded content in the server 114 in any suitable way. For example, the system may organize uploaded content based on doctor factors and content factors. Doctor factors may be the doctor factors discussed above with reference to FIG. 2. Content factors may include, but are not limited to, the topic of the webinar, the length of the video, intended audience, and/or status as a free webinar or one that must be paid for in advance of viewing. These factors may be used by the system when executing algorithms to match content to a user request. A scoring algorithm, such as one described above, may be used to identify one or more content segments responding to a user request. The user request may be received at any suitable time in any suitable way may be a request an express request for content. Alternatively or additionally, the request may be an implied request arising from an interaction with the system that indicates that a user may benefit from content. For example, the user request may be implied from a request from the patient for a doctor specializing in a specific disease. Such a request, for example, may be fulfilled by information about the disease instead of or in addition to a connection to a healthcare provider.

Regardless of how the content may be used, process 500 proceeds to act 508, where the system may store the content in any suitable way. For example, the system may store the uploaded webinars in a database associated with server 114. Alternatively, the webinars may be stored in cloud storage.

Next, process 500 proceeds to act 510, where the system may receive search criteria to search through the webinars in any suitable way. For example, the system may receive a search criteria based on patient factors, as described above with reference to FIG. 2, which are entered into graphical user interface 524 as shown in FIG. 5B. The search criteria may be included as part of an express or implicit request for content.

Next, process 500 proceeds to act 512, where the system may perform a search of the stored webinars in any suitable way. For example, the system may identify content matching the search criteria. The system may then filter the result set based on the patient factors. For example, if the search query specifies information about a specific disease, the system may identify multiple content segments relating to that disease. However, the system may present the user only those content segments that score highly relative to patient factors. As a specific example, if the patient has previously been treated for the disease, filtering may reduce the result set up to only content segments relating to a relapse of the disease. Alternatively or additionally, the system may order the result set for presentation to the user based on patient factors such that content segments that score highly relative to the patient factors appear first in the presentation of the search results.

Next, process 500 proceeds to act 514, where the system may provide access to a content library to the user in any suitable way. The presentation may only a subset of the content elements in the content library. For example, the presentation may include only include content segments in the result set of a search as illustrated in FIG. 5b, a content library of embedded video webinars is displayed. A user may choose a webinar 522, which may be displayed on graphical user interface 524 next to the sponsor logo 530, as illustrated in FIG. 5c.

It should be appreciated that there is no requirement that content, as described in FIGS. 5a-5c, be stored in a database before being presented to a user. In some embodiments, content may be streamed live to multiple users. Such an approach may be useful, for example, when the content is a conference or teaching session.

In some embodiments, the content may be audio video content recorded in a professional studio. A professional recording may be used, for example, for sponsored content. However, it should be appreciated that, in some embodiments or in some scenarios, less formal recording of content may be desirable. For example, a recording may be made with a webcam. Moreover, instead of or in addition to audio video content, the content may include text or graphics. Text, for example, may be generated using speech recognition systems. Such an approach, for example, may enable subtitles for those who are deaf to be added.

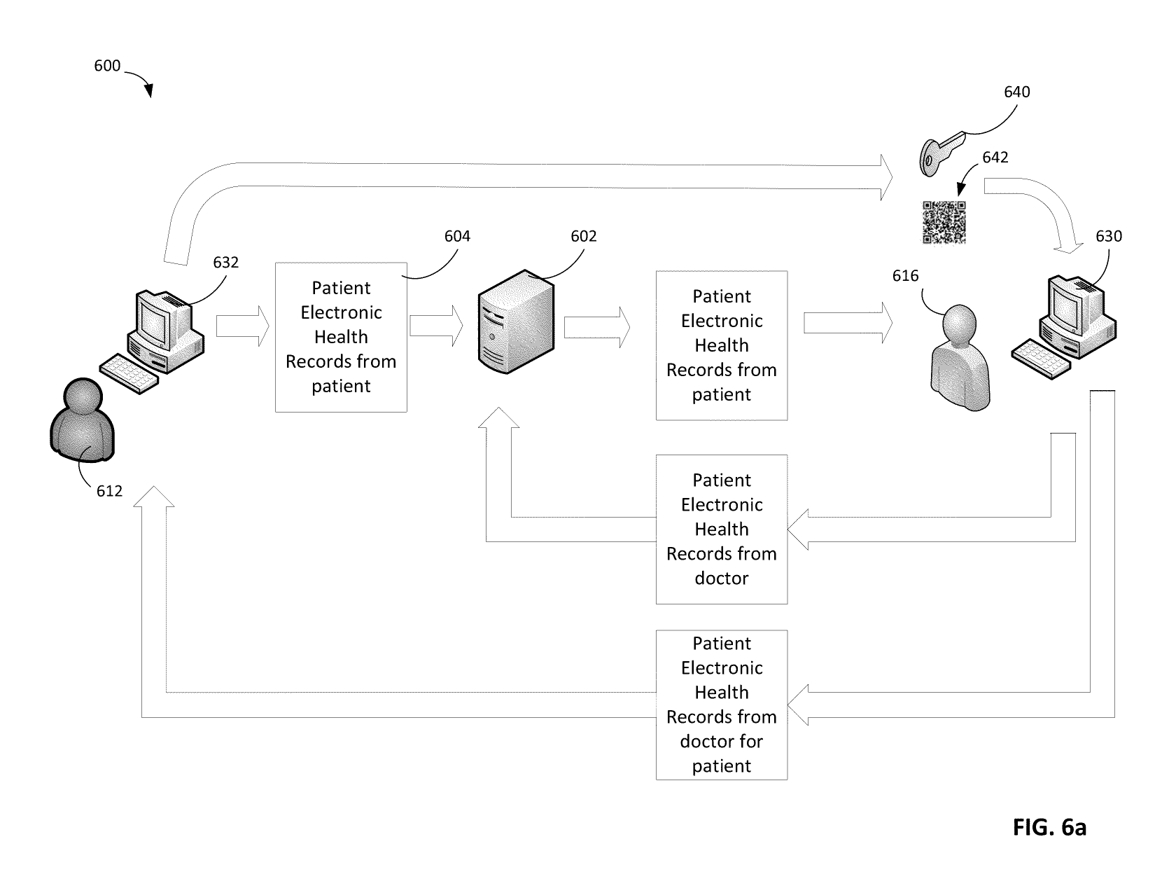

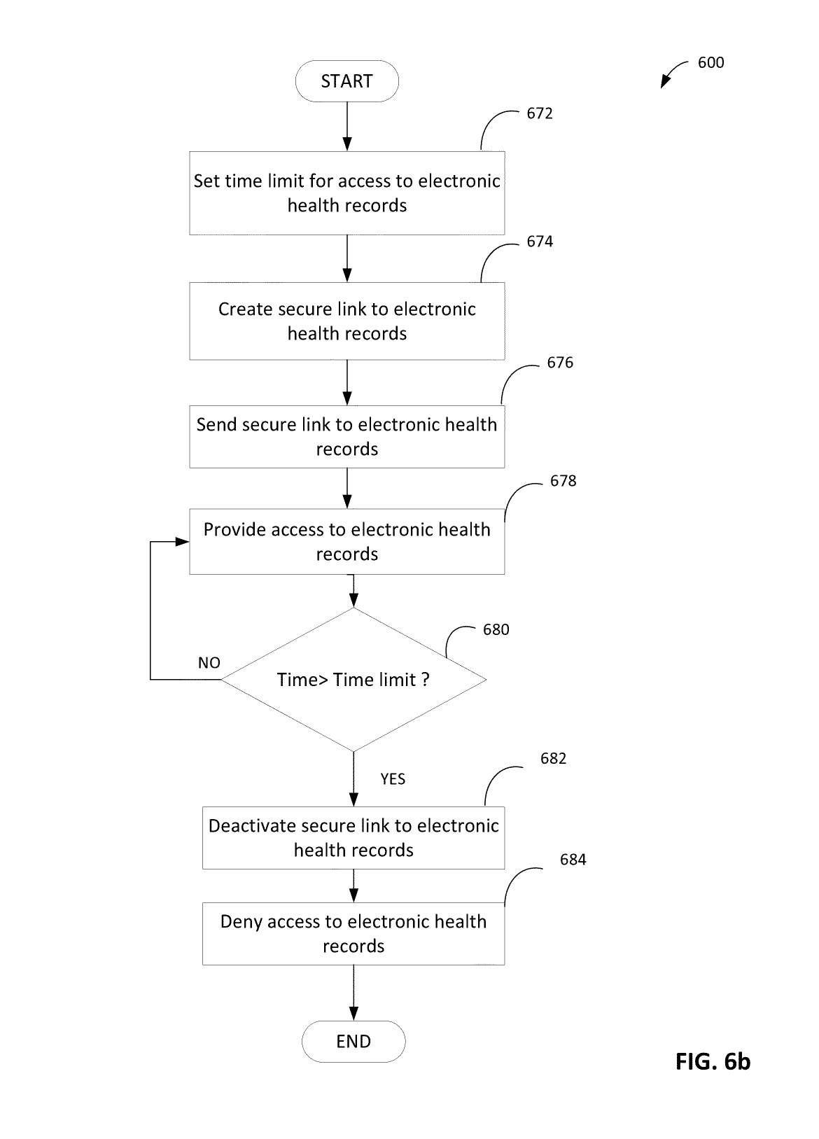

FIGS. 6a-6b show data flow diagrams of illustrative process 600 for allowing access to electronic health records within the online healthcare delivery system 100. The health records may be input into the system in any suitable way, including by patient input or by electronic data exchange with another system or systems that store all or portions of a patient's healthcare record. For example, a patient 612 may share the patient's healthcare records with a healthcare provider 616. The system may make healthcare information available in a secure fashion. For example, the system may comply with HIPAA standards for security and privacy and may communicate information formatted in accordance with HL7, or any other suitable format. Process 600 may be executed by any computing device, for example. In particular, in some embodiments, some or all of the acts of process 600 may be performed by processor 1220 described with reference to FIG. 12.

In this example, user 612 and 616 are illustrated. In the embodiment illustrated, user 612 is a patient and user 616 is a doctor. Each user has a computing and viewing device 632 and 630, respectively. A server 602 may be included to store electronic health records.

Patient records may be stored in the database associated with server 602 in any suitable way. In some embodiments, health records about the patient may be received in any one of multiple formats. Server 602 may convert those health records to a common format and store them securely. A patient may manually upload electronic health records to the server 602. Alternatively, the patient may transfer records in various formats from compatible third-party health record management platforms including, for example, iOS HealthKit, Google Fit and/or Microsoft Vault. Alternatively or additionally, the health information associated with the patient may be collected by the system as the system operates. For example, sensors as depicted in FIG. 4 may collect data about the health of the patient, which may be stored as part of the patient's health record by server 602. As another example, a healthcare provider providing a consultation to a patient may generate healthcare information in the course of consulting with the patient.

Process 600 of making patient care records available to the healthcare provider begins in act 672, where the system may receive authorization from the user to grant access to the user's electronic health records in any suitable way. In process 600, the system may set a live time for access to the electronic health records in any suitable way. The system may prompt a user to set the time that a secure link is active. In some embodiments, this time could be 1 week, 1 day, or 1 hour. Alternatively or additionally, the system may select a live time based on the context in which the healthcare information is being shared. For example, if the system is providing healthcare information to support a consultation scheduled within the next hour, the lifetime may be set for one hour. Conversely, if the information is being provided as part of a treatment program that may span weeks or months, the live time may be set for multiple months. In some embodiments, the system may suggest an automatically selected lifetime to a patient, and apply that live time only upon confirmation by the patient.

Next, process 600 proceeds to act 674, where the system may generate security and access information for the electronic health records in any suitable way. For example, the system may create an encryption key 640 and/or QR code 642 that when clicked, gives access to the patient electronic health records. In some embodiments, the key or other information that provides access to records may be secured cryptographically with an expiration time. The expiration time may be selected to implement the lifetime applicable to that health information. The QR code may retrieve encrypted health records and the key may be used to decrypt them. The system may comply with security standards such as HIPAA security and privacy standards, for example, and may communicate information using HL7, or any other suitable format. Moreover, any request to provide access to health records, or any access or security information related to health records, may also be sent in encrypted format. Such encryption may be based, for example, on pre-shared keys or key exchange protocols. As a specific example, doctors and patients may enroll with the system and, in doing so, may be granted credentials or other information that can serve as an encryption key, which may be used to encrypt health information or information used to access health information.

Next, process 600 proceeds to act 676, where the system may send the secure link in any suitable way. As illustrated in FIG. 6a, the patient 612 sends a key 640 or a QR code 642 to the doctor's computing device 630. To facilitate security, the key may be communicated over a computer network using a key exchange protocol or other suitable mechanism. Those mechanisms may rely on credentials issued to the healthcare provider receiving the key upon becoming a user of the system. Alternatively or additionally, the key may be communicated through other channels that do not involve communication over a network.

Next, process 600 proceeds to act 678, where the system may provide access to the electronic health records in any suitable way. For example, a doctor may click the QR code 642 and then enter the key 640 such that the patient's electronic health records may be downloaded from server 602. In some embodiments, QR code 642 may encode the key as well as address information identifying the patient health record. It should be appreciated that the address may be the web address of a server managing a database of patient health information. Alternatively or additionally, that address may identify one or more data streams or other sources of data and/or may provide information to access data from those data sources. For example, FIG. 4 illustrates external devices that may collect data relating to a patient and provide it to a computing device used by the patient. The captured data as stored on the patient's computing device may be a data source identified by the QR code. Alternatively or additionally, an address may provide a mechanism to access an external device, and the data source may be the external device itself. Access may be protected by a firewall of other security mechanism such that information protected by the security mechanism can be accessed with information in the QR code.

Next, process 600 proceeds to act 680, where the system may decide if the secure link has expired. Such a determination may be made by checking whether the live time limit is passed, or in any suitable way. For example, when the secure key or QR code is sent, a timestamp may be triggered which sets the start time. A current time is tracked to determine a total time the key or code is live. The total time may be measured as the difference between the current time and the start time. The total live time may be measured against the set live time limit. If the total live time exceeds the set live time, then the access has expired. If not, the doctor can continue to access the records. It should be appreciated that any suitable met in this sum may be employed to implement a limited time during which health information may be accessed. Further, the health information may be encoded in a file with digital rights management that provides other security functions, such as restricting printing, copying or decrypting, except on a computer associated with the user to which a key for accessing the information was issued.

Next, process 600 proceeds to acts 682 and 684, where the system may deny access to the health records in any suitable way if the time recorded since the time the link was sent exceeds the live time of the link and/or if the user requesting the information is not authenticated. For example, the system may deactivate the secure link or QR code so that when clicked, the link does not load the patient electronic health records. As illustrated in FIG. 6a, the patient electronic health records are sent back to the server. Additionally and/or optionally, records created by the doctor for the patient can be sent to the server 620 so that these records will be added to the patient's record database.

In the foregoing example, the system is described as providing, in a secure way, medical records about a specific patient to a doctor. Such a system may be used in other ways. For example, the doctor may be able to search the database of health records based on symptoms described by a patient. Diagnosis and treatment information for other patients having similar reported symptoms may be thus identified. In some embodiments, that identification may be performed by server 602 or other suitable device that is not under control of a user of the system. That server may run one or more pattern matching algorithms to identify stored records of patients with similar symptoms. Upon identifying a matching patient record, information about that patient's diagnosis, treatment and/or recovery may be provided without revealing personally identifiable information. In this way, health records of other patients may serve as a source of treatment information without compromising privacy.

It should be appreciated, however, that any source of information relating to diagnosis or treatment may be maintained and/or accessed by a doctor providing health care services to a patient. A doctor, for example, may access pre-stored information about a medical condition, including home health care for that condition. The secure communication channels depicted in FIG. 6a may be used to communicate such information to a patient, such that sharing diagnosis or treatment information with that patient does not unintentionally reveal the patient's medical condition.

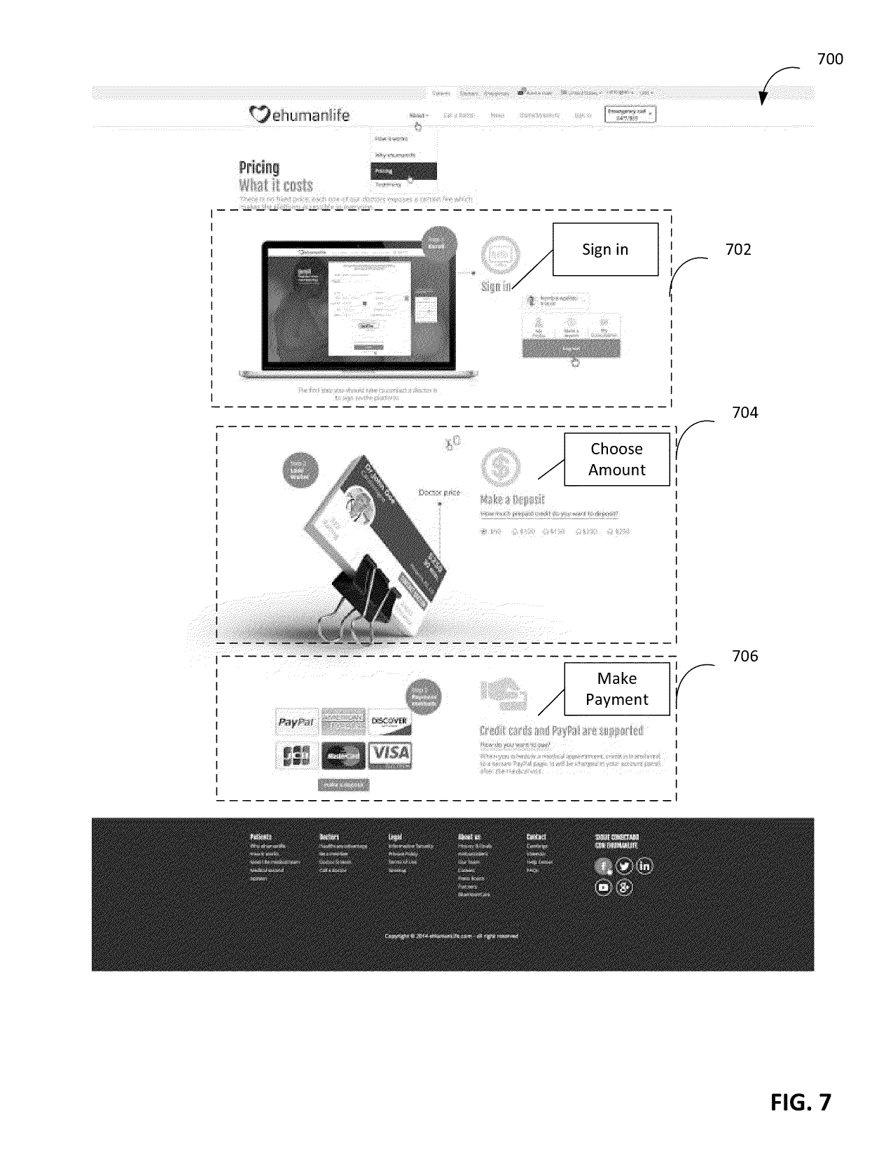

FIGS. 7-11 illustrate exemplary graphical user interfaces through which a user interacts with the online healthcare delivery system. Graphical user interfaces 524, 700, 802, 804, 902, 1000, 1100 and 1300 may be rendered using computer programming techniques as are known in the art. Rendering of the graphical user interface may include rendering controls through which an analyst may input data or select operating parameters of the computing device rendering the graphical user interfaces.

A patient may deposit funds into their account in any suitable way. As illustrated in FIG. 7, a patient may use graphical user interface 700 to make deposits into their account and pay using a charge card.

A patient may schedule an appointment in any suitable way. As illustrated in FIG. 8a, a patient may use graphical user interface 802 to schedule an appointment with a doctor. Scheduling information may be entered by the doctors using the system and the system may identify times when a selected doctor is available. These times may be presented in a user interface, such as shown in FIG. 8A.

A patient may make payments for services rendered in any suitable way. As illustrated in FIG. 8b, a patient may use graphical user interface 804 to make a payment to the chosen appointment with the chosen doctor. Alternatively or additionally, the patient and/or the doctor may maintain an account with the system. When a patient is to make a payment, the system may transfer funds from the patient account to the doctor's account. In some embodiments, the system may collect a fee or commission when funds are transferred.

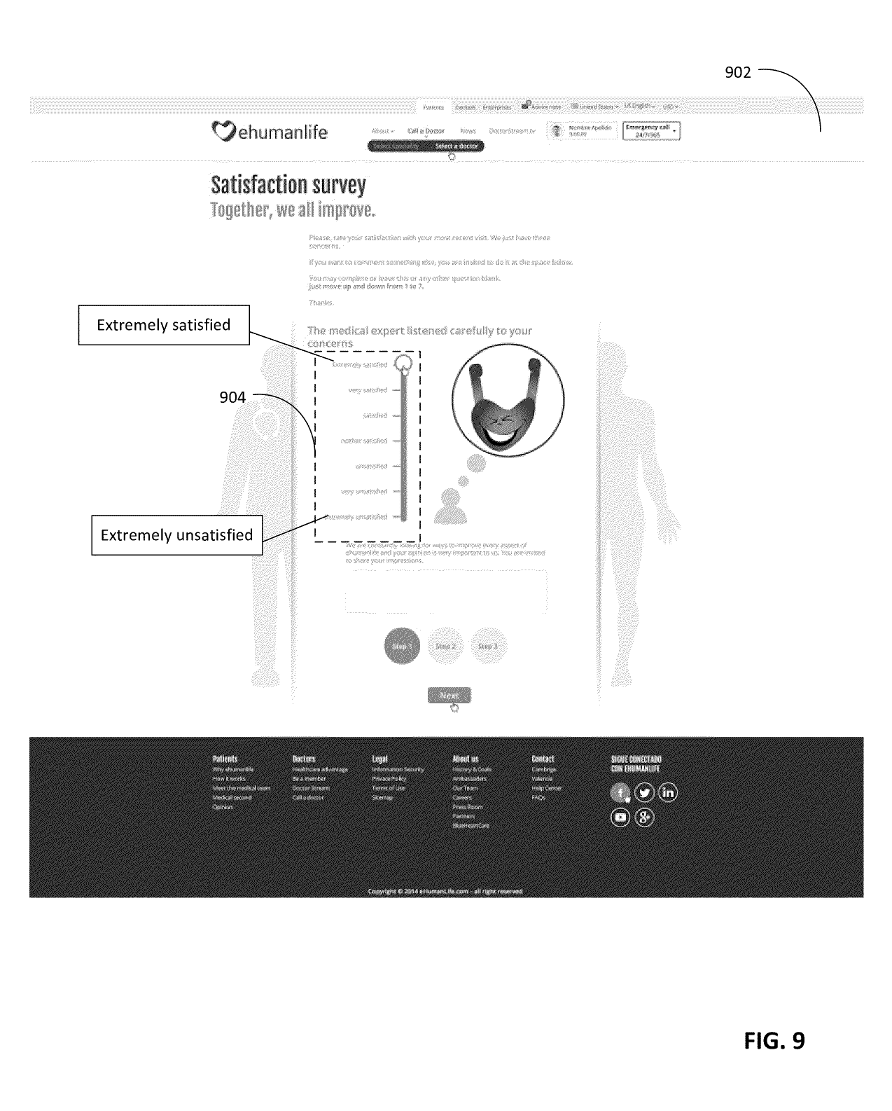

A patient may review the healthcare services received in any suitable way. As illustrated in FIG. 9, a patient may rate how satisfied they were with the service with a scale 904 which starts at “extremely unsatisfied” on one extreme and “extremely satisfied” on the other extreme. This information may be used as a doctor factor in scoring the doctor for providing services to the same or other patients.

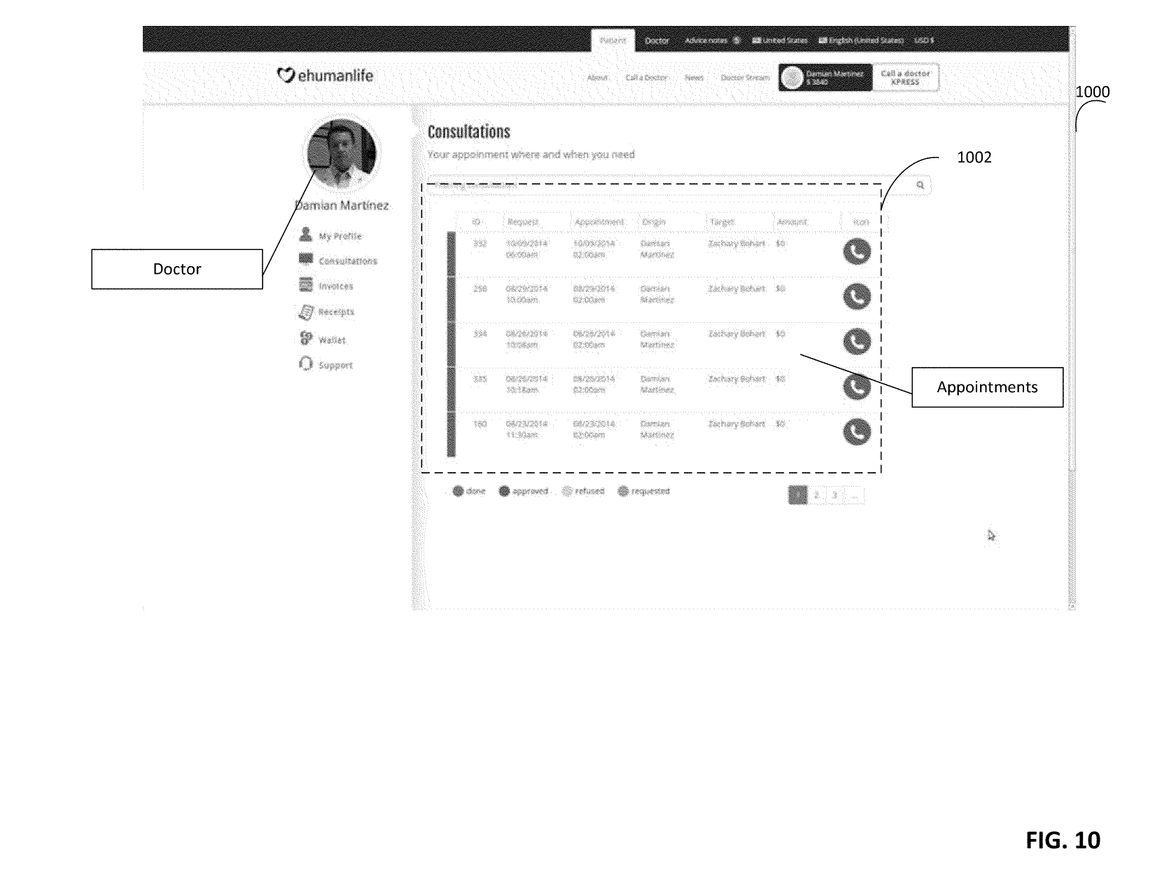

A doctor may manage his online appoints in any suitable way. As illustrated in FIG. 10, a doctor may view appointments in an appointment log 1002. This information, and other information input into the system, also may be used as a doctor factor.

A doctor may manage his billing rate in any suitable way. As illustrated in FIG. 11, a doctor may set a billing rate by entering a value and/or a service time in input field 1104. For example, a doctor may enter a rate of $100 and select a service time of 60 minutes, resulting in a rate of $100 per hour. However, it should be appreciated that a doctor may set any suitable rate by selecting a combination of the amount and service time, such as $50 per 20 minutes. This information, too, may be used as a doctor factor.

However, it should be appreciated that the system is not limited to charging only for interactions between doctors and patients. Nor are those charges limited to charges based on time spent in the interactions. Different types of charges may be imposed for different uses of the system, including making use of the communication functionality of the system or accessing information. Any of the users, for example, whether doctors or patients, may pay a flat rate to access information or to use the communication functions of the system. Such flat rate charges may allow use of the system over some period of time, such as a month or a year. Alternatively, a flat rate may allow a user use of the system, up to some cap in minutes. Optionally, a separate charge may be made for patients who schedule time with a doctor. Likewise, a separate charge may be imposed for viewing a webinar or accessing other content. Accordingly, in some embodiments, the system may be programmed to detect and record events that generate charges and to generate billing information accordingly.

The foregoing competitions and other functions may be implemented in any suitable computing device or devices. FIG. 12 illustrates an example of a suitable computing system environment 1200 on which some or all of the computations and/or user interactions described herein may be implemented. For example, computing environment 1200 may represent a user computer, a doctor computer and/or a server.

The computing system environment 1200 is only one example of a suitable computing environment and is not intended to suggest any limitation as to the scope of use or functionality of the invention. Neither should the computing environment 1200 be interpreted as having any dependency or requirement relating to any one or combination of components illustrated in the exemplary operating environment 1200.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 12, an exemplary system for implementing the invention includes a general purpose computing device in the form of a computer 1210. Components of computer 1210 may include, but are not limited to, a processing unit 1220, a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1210 typically includes a variety of computer readable media. Computer readable media can be any available media that can be accessed by computer 1210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1230 includes computer storage media in the form of volatile and/or nonvolatile memory such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, application programs 1235, other program modules 1236, and program data 1237.

The computer 1210 may also include other removable/non-removable, volatile/nonvolatile computer storage media. By way of example only, FIG. 12 illustrates a hard disk drive 1241 that reads from or writes to non-removable, nonvolatile magnetic media, a magnetic disk drive 1251 that reads from or writes to a removable, nonvolatile magnetic disk 1252, and an optical disk drive 1255 that reads from or writes to a removable, nonvolatile optical disk 1256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1241 is typically connected to the system bus 1221 through a non-removable memory interface such as interface 1240, and magnetic disk drive 1251 and optical disk drive 1255 are typically connected to the system bus 1221 by a removable memory interface, such as interface 1250.

The drives and their associated computer storage media discussed above and illustrated in FIG. 12, provide storage of computer readable instructions, data structures, program modules and other data for the computer 1210. In FIG. 12, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237. Operating system 1244, application programs 1245, other program modules 1246, and program data 1247 are given different numbers here to illustrate that, at a minimum, they are different copies. A user may enter commands and information into the computer 1210 through input devices such as a keyboard 1262 and pointing device 1261, commonly referred to as a mouse, trackball or touch pad. Other input devices (not shown) may include a microphone, joystick, game pad, satellite dish, scanner, or the like. These and other input devices are often connected to the processing unit 1220 through a user input interface 1260 that is coupled to the system bus, but may be connected by other interface and bus structures, such as a parallel port, game port or a universal serial bus (USB). A monitor 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1295.

The computer 1210 may operate in a networked environment using logical connections to one or more remote computers, such as a remote computer 1280. The remote computer 1280 may be a personal computer, a server, a router, a network PC, a peer device or other common network node, and typically includes many or all of the elements described above relative to the computer 1210, although only a memory storage device 1281 has been illustrated in FIG. 12. The logical connections depicted in FIG. 12 include a local area network (LAN) 1271 and a wide area network (WAN) 1273, but may also include other networks. Such networking environments are commonplace in offices, enterprise-wide computer networks, intranets and the Internet.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. The modem 1272, which may be internal or external, may be connected to the system bus 1221 via the user input interface 1260, or other appropriate mechanism. In a networked environment, program modules depicted relative to the computer 1210, or portions thereof, may be stored in the remote memory storage device. By way of example, and not limitation, FIG. 12 illustrates remote application programs 1285 as residing on memory device 1281. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a healthcare delivery system to recommend a doctor in response to an indication of need for a doctor for a patient, the method comprising:
with at least one processor of an online healthcare delivery system:
accessing patient factors based at least in part on information received from the patient over a computer network, wherein the patient factors comprise symptom information;
for each of a plurality of doctors:
accessing doctor factors stored in a data store within the online healthcare delivery system, wherein the doctor factors comprise specialty information;
calculating a respective doctor score based on the doctor factors and the patient factors;
sorting at least a portion of the plurality of doctors based on the respective doctor scores.

2. The method of claim 1, wherein:
the sorting is performed in accordance with an algorithm selected based on an indication of urgency associated with the indication of need.

3. The method of claim 2, wherein:
the indication of need comprises an indication of whether the patient is seeking a consultation with a doctor on an emergency basis.

4. The method of claim 2, wherein:
the indication of need comprises an indication of whether the patient is seeking a consultation with a doctor on a non-emergency basis.

5. The method of claim 1, further comprising:
presenting at least the portion of the plurality of doctors as an ordered list, the ordered list comprising a predetermined number of doctors selected based on respective doctor scores.

6. The method of claim 5, further comprising:
receiving patient input over the computer network indicating a selection of a doctor from the ordered list.

7. The method of claim 6, further comprising:
establishing, via the computer network, an audio-video communication session between a selected doctor and the patient.

8. The method of claim 1, further comprising:
automatically selecting a doctor from the at least a portion of the plurality of doctors based on the sorting; and
establishing, via the computer network, a communication session between a selected doctor and the patient.

9. The method of claim 1, wherein:
the patient factors further comprise one or more of location and/or age.

10. The method of claim 1, wherein:
the doctor factors further comprise one or more of location and/orbilling rate.

11. A system for enabling a healthcare professional at a first location to teach a user, at a second location about a healthcare topic, wherein the first location and the second location are coupled to the system via a computer network, and the system comprising:
a source of an image of at least a portion of a human anatomy; and
at least one processor configured with an augmented reality program to provide an augmented reality depiction of an image from the source, wherein:
operation of the augmented reality program is based on input received over the computer network from at least one input device at the first location; and
the at least one processor is further configured to send the augmented reality depiction for display on a computing device at the second location.

12. The system of claim 11, wherein:
the at least one processor is further configured to establish a communication path between the first location and the second location over the computer network, the communication pathway supporting a video conference, whereby a doctor at the first location is enabled to instruct a patient at the second location via a combination of information presented in the video conference and manipulation of the augmented reality via the at least one input device at the first location.

13. The system of claim 12, wherein:
the source of the image is a camera.

14. The system of claim 13, wherein:
the camera is a webcam at the second location.

15. The system of claim 11, wherein:
the at least one input device comprises a mouse;

16. The system of claim 11, wherein:
the at least one input device comprises a headset;

17. An online healthcare delivery system for enabling a patient, at a second location, to consult with a doctor, at a first location, the first location and the second location being connected by a computer network, the system comprising:
at least one computing device configured to:
provide a plurality of communication pathways between the patient and the doctor over the computer network, wherein the plurality of communication pathways comprise:
a first communication pathway for conveying signals representing a video conference; and
a second communication pathway for conveying health signals from a sensor coupled to the patient during the video conference communication.

18. The system of claim 17, wherein:
the sensor comprises at least one of a pulse meter and/or a blood pressure sensor.

19. The system of claim 17, wherein:
the at least one computing device is further configured to receive a request from the patient and provide a recommendation for a doctor.

20. The system of claim 17, wherein:
the at least one computing device is further configured to recommend a doctor in response to an indication of need for a doctor for a patient.

21. The system of claim 17, wherein:
the at least one computing device is further configured to display webinar content.

22. The system of claim 17, wherein:
the at least one computing device is further configured to manage access to electronic health records stored on a server.

23. The system of claim 17, wherein:
the at least one computing device is further configured to enable a healthcare professional at a first location to teach a user, at a second location about a healthcare topic.

24. A method of providing webinar content within an online healthcare system, the steps comprising:
receiving a bid from at least one sponsor to sponsor content generated by a doctor;
determining a selected sponsor based on the at least one bid;
receiving a logo from the selected sponsor;
associating sponsor information with the content;
receiving content from the doctor;
organizing content based on doctor factors and content factors;
storing content in a content library on a server;
receiving search criteria based on patient factors;
performing a search of the content library based on the search criteria;
displaying the content library via embedded video; and
displaying the sponsor information associated with the content adjacent to the content.

25. A method of managing access to electronic health records stored on at least one computing device, the method comprising:
receiving authorization from a patient to provide access to health care records of the patient to a healthcare provider;
generating security and access information for the health care records, wherein at least one of the security and access information has a time limit associated therewith;
providing the security and access information to the healthcare provider.

26. The method of claim 25, wherein:
the authorization is received over a secure connection formed on a public computer network based on pre-established security information for the patient.

27. The method of claim 25, wherein:
the access and security information is transmitted over a secure connection formed on a public computer network based on pre-established security information for the healthcare provider.

28. The method of claim 25, wherein:
the access and security information comprises a QR code.

29. The method of claim 28, wherein:
the access and security information further comprises an encryption key.

30. The method of claim 25, further comprising:
building the healthcare record of the patient by:
receiving health care information in a plurality of formats;
converting the received health care information into a common format; and
storing the information in a common, encrypted format.

31. The method of claim 25, further comprising:
recording a start time when the security and access information is generated;
recording a current time;
determining a time of use based on a difference between the current time and the start time;
comparing the time of use to the time limit;
deactivating the security and access information if the time of use exceeds the time limit; and
denying access to the health care information.
